(19) United States
(12) Patent Application Publication
(10) Pub. No.: US 2025/0125136 A1
(43) Pub. Date: Apr. 17, 2025

(54) Laser Induced Fragmentation for MRM Analysis

(71) Applicant: DH Technologies Development Pte. Ltd., Singapore (SG)

(72) Inventors: Mircea GUNA, Toronto (CA); Yves LE BLANC, Concord (CA)

(21) Appl. No.: 18/696,002

(22) PCT Filed: Sep. 26, 2022
(86) PCT No.: PCT/IB2022/059138

§ 371 Date: Mar. 27, 2024

Related U.S. Application Data
(60) Provisional application No. 63/250,847, filed on Sep. 30, 2021.

(51) Int. Cl. H01J 49/00; H01J 49/42

(52) U.S. Cl. CPC H01J 49/0059; H01J 49/4215

(57) ABSTRACT

In one aspect, a method for fragmenting ions in a mass spectrometer is disclosed, which includes introducing a plurality of precursor ions into a collision cell of a mass spectrometer, generating a potential barrier in the collision cell to cause at least a portion of ions in the collision cell to be trapped within a region in proximity of said potential barrier, and applying ultraviolet (UV) radiation to said trapped ions so as to cause fragmentation of at least a portion of any of said precursor ions and fragment ions thereof to generate a plurality of product ions such that a space charge generated in said region in proximity of said potential barrier due to accumulation of ions will impart sufficient kinetic energy to at least a portion of the product ions so as to overcome said potential barrier, thereby exiting said region.

### BACKGROUND

The present disclosure is generally directed to a mass spectrometer as well as methods and systems for performing mass spectrometry, e.g., mass spectrometers in which SRM (selected reaction monitoring) is employed for elucidating the structure of an analyte.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

By way of illustration, FIG. 2C schematically depicts the arrival of a plurality of precursor ions (illustrated by dotted circles) at the potential barrier (PB) and the photofragmentation of a portion of those precursor ions to generate a plurality of product ions (illustrated by cross-hatched circles). This figure also schematically depicts that as the accumulation of the precursor ions and the product ions increases the repulsive forces between the ions will impart sufficient kinetic energy to at least some of those ions to allow them to overcome the potential barrier.

MRM (multiple reaction monitoring) mass spectrometry is a highly specific, label-free type of tandem mass spectrometry in which a plurality of precursor ions having m/z ratios within a predefined target range are subjected to fragmentation to generate a plurality of product ions. The mass spectrum of the product ions is acquired and analyzed to obtain information about the precursor ions. Some examples of techniques employed to cause fragmentation of the precursor ions include, without limitation, collision induced dissociation (CID) and electron induced dissociation (EID). Though these fragmentation techniques are routinely employed for mass spectrometric analysis of a variety of compounds, there is still a need for improved systems and methods for ion fragmentation, which can be employed in tandem mass spectrometry.

### SUMMARY

In one aspect, a method for fragmenting ions in a mass spectrometer is disclosed, which includes introducing a plurality of precursor ions into a collision cell of a mass spectrometer, generating a potential barrier in the collision cell to cause at least a portion of ions in the collision cell to be trapped within a region in proximity of said potential barrier, and applying ultraviolet (UV) radiation to said trapped ions so as to cause fragmentation of at least a portion of any of said precursor ions and fragment ions thereof to generate a plurality of product ions such that a space charge generated in said region in proximity of said potential barrier due to accumulation of ions will impart sufficient kinetic energy to at least a portion of the product ions so as to overcome said potential barrier, thereby exiting said region.

The potential barrier can be disposed in different locations of the collision cell. Typically, the potential barrier can be located at a position of the collision cell such that ions received by the collision cell will undergo sufficient collisional cooling before arriving at the potential barrier so that the potential barrier can inhibit their propagation through the collision cell and hence cause their accumulation in a region in proximity of the potential barrier.

In some embodiments, the potential barrier is located in proximity of, or at, an outlet of the collision cell. In some other embodiments, the potential barrier can be disposed at a location in the collision cell that is between an inlet and an outlet of the collision cell.

In some embodiments, the collision cell can be maintained at a pressure suitable for causing collisional cooling of a plurality of precursor ions received in the collision cell without causing their collisional fragmentation. By way of example, in some such embodiments, the gas pressure in the collision cell can be in a range of about 2 mTorr to about 15 mTorr, and the ion energy can be in a range of about 5 eV to about 150 eV, though other pressures and ion energies may also be employed.

In other embodiments, the energy of the ions and the pressure of the gas in the collision cell can be selected such that at least a portion of the precursor ions will undergo fragmentation before reaching the potential barrier. As discussed in more detail below, such fragment ions can be exposed to UV radiation having a wavelength that can be absorbed by the fragment ions and cause their photofragmentation to generate a plurality of product ions (herein also referred to as the final product ions).

The potential barrier can be generated, for example, via application of a DC and/or an RF voltage to an electrode coupled to the collision cell. By way of example, in some embodiments, a DC potential barrier in a range of about 0.05 volts to about 1.5 volts can be provided.

The method can further include introducing a plurality of ions into a mass filter positioned upstream of the collision cell so as to select a plurality of precursor ions having m/z ratios within a target range for transmission into the collision cell for causing photofragmentation thereof via exposure to the UV radiation so as to generate a plurality of product ions.

The product ions can be transmitted into a mass analyzer that is disposed downstream of the collision cell for generating a mass spectrum thereof. In some embodiments, the mass analyzer can be a quadrupole mass analyzer, though other types of mass analyzer, such as time-of-flight (ToF) mass analyzers can also be employed.

In some embodiments, the mass analyzer can include and/or can be in the form of an ion trap, e.g., a linear ion trap, an orbitrap, and an electrostatic trap, among others. By way of example, in such embodiments, the UVPD-generated fragment ions can be captured by the ion trap and the captured fragment ions can be mass selectively ejected into a downstream mass analyzer (e.g., a time-of-flight mass analyzer).

In some embodiments, the potential barrier is generated at a location within the collision cell by applying a DC or an RF voltage to a conductive electrode coupled to the collision cell. By way of example, the conductive electrode can be coupled to the collision cell in proximity of its inlet, in proximity (or at) its outlet, or at a location between the inlet and the outlet of the collision cell. In some embodiments, the conductive electrode is positioned at a distance relative to the inlet of the collision cell such that the ions entering the collision cell will undergo sufficient collisional cooling before reaching the potential barrier so as to allow the potential barrier to trap the ions and cause their accumulation in a region in proximity of the potential barrier where the ions can be irradiated to cause photofragmentation of at least a portion of the trapped ions.

In a related aspect, a mass spectrometer is disclosed, which includes a collision cell having an inlet for receiving ions and an outlet through which ions can exit the collision cell. At least one electrode is coupled to the collision cell and is configured for application of a voltage thereto to generate a potential barrier for trapping at least a portion of ions in the collision cell within a region in proximity of the electrode. The mass spectrometer can further include a UV radiation source radiatively coupled to the collision cell to irradiate at least a portion of the trapped ions so as to cause photofragmentation of at least some of those ions, thereby generating a plurality of product ions such that at least a portion of the product ions can overcome the potential barrier to exit said region. By way of example, the potential barrier can be generated via application of a DC and/or an RF voltage to the electrode.

A mass analyzer can be positioned downstream of the collision cell to receive the product ions and generate a mass spectrum thereof. A mass filter can be positioned upstream of the collision cell, where the mass filter positioned upstream of the collision cell is configured to receive a plurality of ions and allow the passage of a plurality of precursor ions having m/z ratios within a target range to said collision cell. In some embodiments, the mass analyzer can include and/or be in the form of an ion trap, such as those discussed above. In some such embodiments, the ion trap can receive and capture the product ions and then release the product ions via a mass-selective ejection.

The collision cell can contain a gas, e.g., nitrogen, at a pressure suitable for causing collisional cooling of at least a portion of the received ions so as to allow the cooled ions to be trapped via the potential barrier generated in the collision cell. By way of example, in some embodiments, the pressure in the collision cell can be, for example, in a range of about 3 to about 15 torr, through other pressures can also be employed.

As noted above, the electrode can be coupled to the collision cell at a plurality of locations along the collision cell. By way of example, the electrode can be positioned in proximity of the inlet, the outlet, or between the inlet and the outlet of the collision cell.

In some embodiments, the collision cell can have a curved profile, e.g., a semi-circular profile, extending from the collision cell's inlet to its outlet.

In some embodiments, the collision cell can include a plurality of rods arranged in a multipole configuration, e.g., a quadrupole configuration, to which RF and/or DC voltages can be applied for generating an electromagnetic field within the collision cell for providing radial confinement of the ions as they pass through the collision cell.

In some embodiments, in addition to the multipole rods, the collision cell can include a pair of auxiliary electrodes (herein also referred to as linac electrodes) that extend along at least a portion of the collision cell and are shaped such that the application of a DC potential difference between them will result in the generation of an axial electric field (i.e., an electric field extending along the collision cell), which can facilitate the motion of the ions along the collision cell.

The linac electrodes can have a variety of different shapes. By way of example, in embodiments, the linac electrodes can have a T-shaped or a blade-shaped configuration such that the depth of penetration of the electrodes toward the center of the collision cell varies along the length of the collision cell so as to provide a substantially uniform electric field along the length of the collision cell.

In some embodiments, the collision cell can have a curved profile, e.g., a semi-circular profile extending from its inlet to its outlet. In such embodiments, the multipole rods and the linac electrodes can also have a curved profile that substantially matches the curved profile of the collision cell.

The mass spectrometer can also include at least one DC and/or one RF voltage source operably coupled to the electrode for generating the potential barrier within the collision cell. A controller can be operably coupled to such DC and/or RF voltage source(s) for controlling thereof.

At least one UV radiation source is optically coupled to the collision cell, e.g., via a UV transparent window, to irradiate at least a portion of the ions trapped by the potential barrier. The angle of entry of the UV radiation beam into the collision cell can be configured to optimize the interaction of the UV radiation with ions trapped via the potential barrier. By way of example, and without limitation, in some embodiments, the angle of the UV radiation beam relative to a putative vector normal to a surface of an electrode coupled to the collision cell for generating the potential barrier can be in a range of about 0 degrees to about 0.5 degrees, such as 0.3 degrees.

In some embodiments, a mass spectrometer according to the present teachings can include multiple potential barriers within the collision cell to provide multiple ion trapping regions. One or more UV radiation sources that are optically coupled to these ion trapping regions can be employed to irradiate the trapped ions (or at least a portion thereof) to cause their photofragmentation. In some embodiments, the mass spectrometer can include multiple UV radiation sources, each of which is optically coupled to one of the ion trapping regions, e.g., via UV transparent windows provided in an evacuated chamber in which the collision cell is positioned as well as in a wall of the collision cell. In other embodiments, one or more optics are employed to direct UV radiation emanating from a single UV radiation source into multiple ion trapping regions, each of which is located in proximity of one of a plurality of potential barriers established within the collision cell.

In some embodiments, two sets of linac electrodes are incorporated in the collision cell of a mass spectrometer according to the present teachings such that a gap region is formed between the distal and the proximal ends of the two sets. In some such embodiments, a DC voltage differential generated between the two sets of linac electrodes can provide a potential barrier for trapping at least a portion of ions entering the collision cell that reach the gap region. A UV radiation source can generate UV radiation, which can be directed, e.g., via one or more UV transparent windows, into the gap region so as to cause photofragmentation of the trapped ions (or at least a portion thereof), thereby generating a plurality of fragment ions. As new ions (e.g., precursor ions and/or collisional fragments of precursor ions) continue to arrive at the potential barrier and as the photofragmentation of the trapped ions continues, the space charge in the proximity of the potential barrier will eventually reach a level at which the kinetic energy imparted to photofragment ions (i.e., ions generated via UV photofragmentation), and in some cases, other ions as well, e.g., precursor ions and/or fragment ions generated via collisional fragmentation of the precursor ions, due to repulsive forces between them is sufficient for the fragment ions (and in some cases at least some of the other ions) to overcome the potential barrier and leave the gap region.

Further understanding of various aspects of the present teachings can be obtained by reference to the following detailed description in conjunction with the associated drawings, which are described briefly below.

### BRIEF DESCRIPTION OF THE DRAWINGS

FIG. 1 schematically depicts a mass spectrometer according to an embodiment of the present teachings,

FIG. 2A schematically depicts a cross-section of the collision cell incorporated in the mass spectrometer depicted in FIG. 1 as viewed from the outlet end of the collision cell,

FIG. 2B schematically depicts a cross-section of the collision cell incorporated in the mass spectrometer depicted in FIG. 1 as viewed from the inlet end of the collision cell,

FIG. 2C schematically depicts accumulation of a plurality of precursor and product ions at a potential barrier generated within a collision cell such that the repulsive forces between the accumulated ions impart sufficient kinetic energy to at least a portion of those ions for overcoming the potential barrier,

FIG. 3 schematically depicts a mass spectrometer according to another embodiment in which a potential barrier is provided in proximity of an inlet of its collision cell,

FIG. 4 schematically depicts a mass spectrometer according to another embodiment in which two potential barriers are provided within the collision cell, where one potential barrier is located in proximity of an inlet of the collision cell and another potential barrier is located at the outlet of the collision cell,

FIGS. 5A and 5B show, respectively, the cross sections of the collision cell incorporated in the mass spectrometer of FIG. 4, where FIG. 5A presents a view for the outlet end of the collision cell and FIG. 5B presents a view from the inlet end of the collision cell,

FIG. 6A schematically depicts a mass spectrometer according to another embodiment in which two sets of linac electrodes are incorporated with the collision cell of the mass spectrometer, where the distal end of one set of the linac electrodes is separated from the proximal end of the other linac electrode to provide a gap region therebetween in which ions can be trapped,

FIGS. 6B and 6C show cross sections of the collision cell incorporated in the mass spectrometer of FIG. 6A, where FIG. 5A presents a view for the outlet end of the collision cell and FIG. 5B presents a view from the inlet end of the collision cell,

FIG. 7A shows the mass signal intensity associated with a precursor ion and a fragment of the precursor ion at m/z 97 as a function of a DC voltage applied to the IQ3 electrode,

FIG. 7B shows the mass signal intensity associated with a precursor ion and a fragment of the precursor ion at m/z 97 as a function of a difference between IQ3 and RO2 (rod offset voltage 2)

FIG. 8A shows normalized mass signals corresponding to a precursor testosterone ion with the UV laser on,

FIG. 8B shows normalized mass signals corresponding to fragment ions at m/z 97 with the UV laser on,

FIG. 8C shows normalized mass signals corresponding to fragment ions at m/z 109 with the UV laser on,

FIG. 8D shows normalized mass signals corresponding to a precursor testosterone ion with the UV laser off,

FIG. 8E shows normalized mass signals corresponding to fragment ions at m/z 97 with the UV laser off,

FIG. 8F shows normalized mass signals corresponding to fragment ions at m/z 109 with the UV laser off,

FIG. 9A shows the MRM 298/97 mass signal for a sample of 24 μg of pure testosterone standard using CID fragmentation mode,

FIG. 9B shows the MRM 298/97 mass signal for a sample of 24 μg of pure testosterone standard using UVPD fragmentation mode,

FIG. 9C shows the MRM 298/97 mass signal for a gel matrix alone using CID fragmentation mode,

FIG. 9D shows the MRM 298/97 mass signal for a gel matrix alone using UVPD fragmentation mode,

FIG. 9E shows the MRM 298/97 mass signal for a sample of 2.4 pg of testosterone incorporated in a gel matrix using CID fragmentation mode,

FIG. 9F shows the MRM 298/97 mass signal for a sample of 2.4 pg of testosterone incorporated in a gel matrix using UVPD fragmentation mode,

FIG. 9G shows the MRM 298/97 mass signal for a sample of 24 μg of testosterone incorporated in a gel matrix using CID fragmentation mode,

FIG. 9H shows the MRM 298/97 mass signal for a sample of 24 μg of testosterone incorporated in a gel matrix using UVPD fragmentation mode,

FIG. 10A compares the MRM 298/97 mass signals as a function of elution time for a blank gel matrix using CID and UVPD fragmentation modes,

FIG. 10B compares the MRM 298/97 mass signals as a function of elution time for a sample containing 2.4 pg of testosterone in a gel matrix using CID and UVPD fragmentation modes,

FIG. 10C compares the MRM 298/97 mass signals as a function of elution time for a sample containing 24 μg of testosterone in a gel matrix using CID and UVPD fragmentation modes,

FIG. 11A compares the MRM 298/109 mass signals as a function of elution time for a blank gel matrix using CID and UVPD fragmentation modes,

FIG. 11B compares the MRM 298/109 mass signals as a function of elution time for a sample containing 2.4 pg of testosterone in a gel matrix using CID and UVPD fragmentation modes,

FIG. 11C compares the MRM 298/109 mass signals as a function of elution time for a sample containing 24 μg of testosterone in a gel matrix using CID and UVPD fragmentation modes,

FIG. 12A compares the MRM 315/97 mass signals as a function of elution time for a blank gel matrix using CID and UVPD fragmentation modes,

FIG. 12B compares the MRM 315/97 mass signals as a function of elution time for a sample containing 2.4 pg of progesterone in a gel matrix using CID and UVPD fragmentation modes,

FIG. 12C compares the MRM 315/97 mass signals as a function of elution time for a sample containing 24 μg of progesterone in a gel matrix using CID and UVPD fragmentation modes,

FIG. 12D compares the MRM 315/109 mass signals as a function of elution time for a blank gel matrix using CID and UVPD fragmentation modes,

FIG. 12E compares the MRM 315/109 mass signals as a function of elution time for a sample containing 2.4 pg of progesterone in a gel matrix using CID and UVPD fragmentation modes,

FIG. 12F compares the MRM 315/109 mass signals as a function of elution time for a sample containing 24 μg of progesterone in a gel matrix using CID and UVPD fragmentation modes,

FIG. 13A shows the 289/97 and 289/109 MRM transitions of testosterone acquired using UVPD fragmentation modality using a 5-minute LC elution gradient,

FIG. 13B shows the 289/97 and 289/109 MRM transitions of testosterone acquired using CID fragmentation modality using a 5-minute LC elution gradient,

FIG. 13C shows the 289/97 and 289/109 MRM transitions of testosterone acquired using UVPD fragmentation modality using a 2-minute LC elution gradient,

FIG. 13D shows the 289/97 and 289/109 MRM transitions of testosterone acquired using CID fragmentation modality using a 2-minute LC elution gradient,

FIG. 14A shows theoretically-calculated ion ratios versus concentration for a standard testosterone solution for UVPD fragmentation modality,

FIG. 14B shows theoretically-calculated ion ratios versus concentration for a standard testosterone solution for CID fragmentation modality,

FIG. 14C shows measured ion ratios versus concentration for a standard testosterone solution for UVPD fragmentation modality,

FIG. 14D shows measured ion ratios versus concentration for a standard testosterone solution for CID fragmentation modality,

FIG. 15A shows the fragmentation result for 100 pg/μL of a mixture of 6 steroids, namely, HO-Testosterone, Mestrolone, CH3-Testosterone, Androstenedione, Androsterone, OH-Progesterone using CID fragmentation mode,

FIG. 15B shows the fragmentation result for 100 pg/μL of a mixture of 6 steroids, namely, HO-Testosterone, Mestrolone, CH3-Testosterone, Androstenedione, Androsterone, OH-Progesterone using UVPD fragmentation mode,

FIG. 15C shows the fragmentation result for a blank gel matrix using CID fragmentation mode,

FIG. 15D shows the fragmentation result for a blank gel matrix using UVPD fragmentation mode,

FIG. 16A shows simulated ion trajectories within a collision cell according to an embodiment in which a DC potential applied to an ion lens (IQ3) positioned in proximity of the collision cell's outlet creates a barrier behind which ions are accumulated,

FIG. 16B shows calculated DC potential in the collision cell illustrated in FIG. 16A as a function of distance from the IQ3 lens, and

FIG. 16C shows calculated equilibrium position of the ions in the collision cell illustrated in FIG. 16A for three voltages applied to the IQ3 lens.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As discussed below, embodiments of the present teachings are related to the use of UV radiation for causing photofragmentation of ions in a collision cell. In some embodiments, the ions enter the collision cell and do not undergo any collisional fragmentation before teaching a potential barrier at which the ions can be trapped to be exposed to UV radiation. In other embodiment, ions entering the collision cell (or at least a portion thereof) may undergo collisional fragmentation before reaching the potential barrier. For ease of description, in the following discussion, the ions reaching the potential barrier will be referred to as “precursor ions” before undergoing photofragmentation via exposure to UV radiation and the fragment ions generated via UV photofragmentation of the precursor ions will be referred to as “product ions.” In some cases, the precursor ions are themselves fragment ions generated via collisional fragmentation of ions entering the collision cell.

The present disclosure relates generally to systems and methods for fragmenting ions in a mass spectrometric system, which can be utilized in tandem mass spectrometry, for example, for MRM mass analysis. Interference elimination/background reduction is an important part of MRM analysis. In fact, interferences are typically the limiting factor in detectability and quantitation of a compound via MRM mass analysis, which may prolong the development of LC-MS analytical methods and may also lead to more complex and longer sample preparation and/or the need for chromatography to minimize the interference effects.

The inventors have found that the fragmentation of ions based on the present teachings can provide enhanced specificity, e.g., via interference rejection, among other advantages, thus resulting in improved detectability and quantitation limit in tandem mass spectrometric analysis of compounds. The present teachings for ion fragmentation can be used in conjunction with the existing ion fragmentation techniques, such as CID and EID, as complementary to such techniques or they can be employed without using other fragmentation techniques.

In embodiments, the present teachings provide laser-based techniques for causing photofragmentation of precursor ions via absorption of the laser radiation by one or more chromophores in the molecular structure of the precursor ions. In particular, in embodiments, UV (ultraviolet) radiation can be used for photodissociation of ions. Such UV photodissociation (UVPD) can provide fine tuning of the dissociation energy relative to collision energy, and hence improve selectivity and sensitivity. As discussed in more detail below, in some embodiments, the present teachings implement such UVPD approach by providing a potential barrier (e.g., a DC and/or an RF potential barrier) at one or more locations in a collision cell containing a gas such that at least a portion of the incoming ions will be sufficiently cooled via collisions with the background gas before reaching the barrier, thereby allowing the potential barrier to inhibit the continued propagation of the ions and hence cause their accumulation in a region (typically a narrow region) in proximity of the barrier. By way of example, and without limitation, in some embodiments, the region behind the potential barrier in which the ions are accumulated can extend a distance in a range of about 2 mm to about 10 mm from an electrode to which a voltage is applied for generating the potential barrier. As discussed in more detail below, in some embodiments, the barrier can be implemented by coupling a conductive electrode to the collision cell and applying a DC and/or an RF voltage to that electrode.

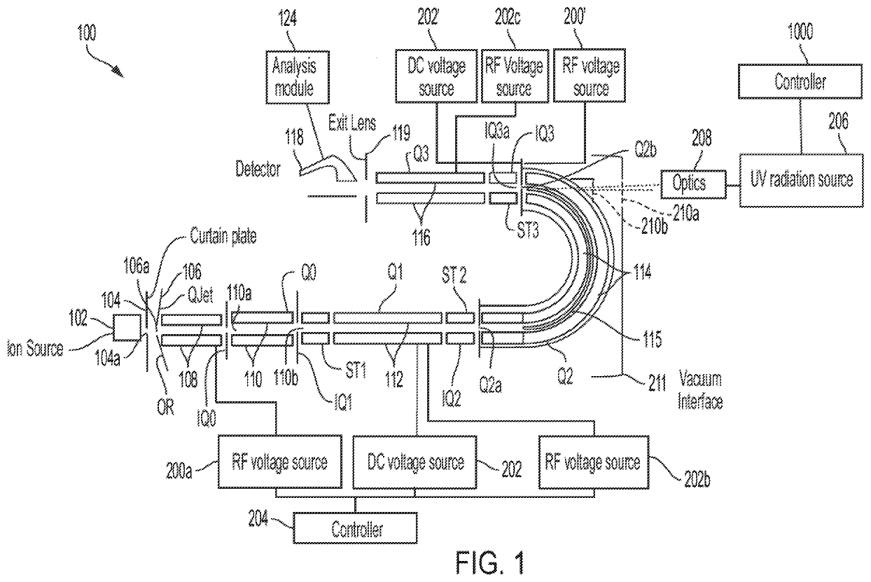

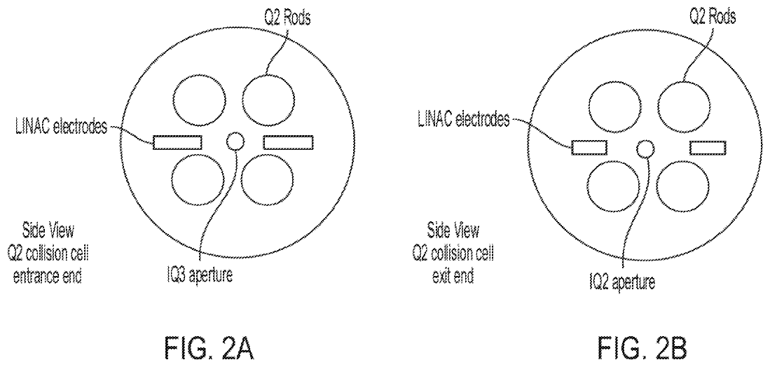

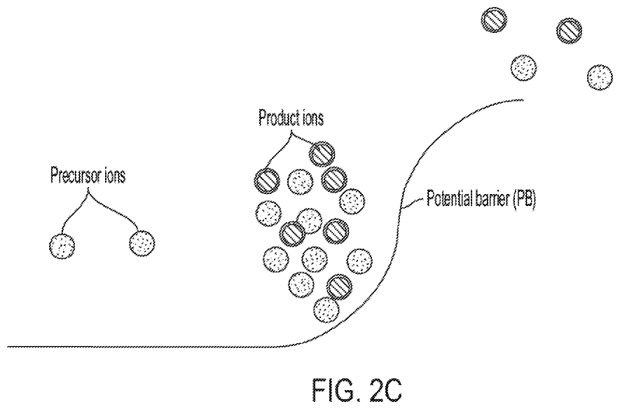

With reference to FIG. 1, a mass spectrometer 100 according to an embodiment includes an ion source 102 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, an atmospheric pressure chemical ionization source (APCI), and an electron impact ion source, among others.

The generated ions pass through an aperture 104a of a curtain plate 104 and an orifice 106a of an orifice plate 106, which is positioned downstream of the curtain plate 104 and is separated from the curtain plate 104 such that a gas curtain chamber is formed between the orifice plate 106 and the curtain plate 104. A curtain gas supply (not shown) can provide a curtain gas flow (e.g., of nitrogen) between the curtain plate 104 and the orifice plate 106 to help keep the downstream sections of the mass spectrometer clean by de-clustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions passing through the orifices 104a and 106a of the curtain plate 104 and the orifice plate 106 are received by an ion optic QJet, which comprises four rods 108 (two of which are visible in this figure) that are arranged in a quadrupole configuration to form an ion beam for transmission to downstream components of the mass spectrometer 100. In use, the ion optic QJet can be employed to capture and focus the ions received through the opening of the orifice plate 106 using a combination of gas dynamics and radio frequency fields.

The ion beam exits the ion optic QJet and is focused via a lens IQ0 into a subsequent differentially pumped vacuum stage with an additional ion guide Q0 that can include a mass filter. In some embodiments, the pressure of the ion guide Q0 can be maintained, for example, in a range of about 2 mTorr to about 20 mTorr.

The ion guide Q0 includes four rods 110 (two of which are visible in this figure), which are arranged according to a quadrupole configuration to provide a passageway therebetween that extends from an inlet 110a through which ions can enter the passageway to an outlet 110b through which ions can exit the passageway. As noted above, in this embodiment, the ion guide Q0 receives, via the ion lens IQ0, the ions exiting the ion optic Qjet.

An RF voltage source 200a applies RF voltages to the Qjet rods, and another RF voltage source 200b applies RF voltages to a set of quadrupole rods 112 of the Q1 mass filter (two of which are visible in the figure), where the RF voltages applied to the rods of the Q1 mass filter are capacitively coupled to the Q0 rods as well as to two Brubaker lenses ST1 and ST2. A DC voltage source 202 can apply a resolving DC voltage to the rods of the Q1 mass analyzer to set the bandpass of the mass analyzer so as to allow the passage of ions having a target m/z or m/z within a target window while inhibiting the passage of ions having other m/z ratios.

An RF voltage source 202c applies RF voltages to the quadrupole rods of the Q3 mass analyzer, where the RF voltages applied to the Q3 rods are capacitively coupled to Q2 rods 114 (two of which are visible) and to Brubaker lens ST3. The RF voltages generate an electromagnetic field within a space between the rods through which ions pass so as to provide radial confinement of the ions. In this embodiment, the RF voltage applied to one pair (i.e., one pole) of a set of quadrupole rods has the same amplitude and an opposite phase relative to the RF voltage applied the other pair (i.e., the other pole) of the rods.

The ions exiting the Q0 ion guide are received by the mass analyzer Q1 that is disposed in a chamber (not shown in the figure) maintained at a lower pressure than a chamber in which the Q0 ion guide is disposed. For example, the Q1 mass analyzer can operate at a pressure of less than about 0.3e-5 Torr to about 4e-5 Torr.

A controller 204 can control the RF and DC voltage sources so as to adjust the RF and DV voltages generated by these voltage sources. In particular, the controller can sweep the amplitude of the DC resolving voltage so as to change the bandpass of the mass filter to allow ions with different m/z ratios to pass through the mass filter to be subjected to mass analysis by downstream components of a mass spectrometer in which the ion guide Q0 and the mass analyzer Q1 are incorporated.

In this embodiment, the ions selected by the mass analyzer Q1 are focused via the stubby lens ST2 and the ion lens IQ2 into a collision cell Q2. In this embodiment, the collision cell Q2 has a curved profile with a semi-circular cross-sectional shape and extends from an inlet Q2a to an outlet Q2b.

In this embodiment, the collision cell Q2 is in the form of a pressurized compartment that can be maintained, e.g., at a pressure in a range of about 1 mTorr to about 20 mTorr, though other pressures can also be used for this or other purposes. A suitable collision gas (e.g., nitrogen, argon, helium, etc.) can be provided by way of a gas inlet (not shown). In this embodiment, the pressure in the collision cell Q2 is selected to allow collisional cooling of the precursor ions received from the mass filter Q1 as the ions pass through the collision cell Q2, without causing collisional fragmentation of the ions.

In this embodiment, the collision cell Q2 includes two linac electrodes (one of which 115 is visible in the figure), where each of the linac electrodes is disposed between two of the quadrupole rods, that generate an axial electric field that can urge the precursors ions to move along the longitudinal extent of the collision cell from its inlet to an exit lens IQ3. The linac electrodes can be maintained at the same DC potential via application of DC voltages thereto by the DC voltage source 202. In this embodiment, the collision cell Q2 has a semi-circular profile and hence the quadrupole rods as well as the linac electrodes are also curved to substantially conform to the curved profile of the housing of the collision cell.

The linac electrodes can have a variety of different shapes. By way of example, in embodiments, the linac electrodes can be T-shaped or blade-shaped such that the depth of penetration of the electrodes toward the center of the collision cell varies along the length of the collision cell so as to provide a substantially uniform electric field along the length of the collision cell Q2.

An electrode (which is herein referred to as IQ3 electrode, barrier electrode, exit electrode, or exit ion lens) is coupled to the collision cell Q2 at the outlet thereof. In this embodiment, a DC voltage source 202′ and/or the RF voltage source 204′ can apply a DC and/or an RF voltage to the IQ3 electrode to generate a DC and/or an RF potential barrier in proximity of the outlet of the collision cell Q2. By way of example, the DC voltage can have an amplitude in a range of about 0.05 volts to about 0.8 volts and the RF voltage can have a frequency in a range of about 0.1 MHz to about 5 MHz and an amplitude in a range of about 1 to about 2000 volts (zero-to-peak), though other amplitudes and/or frequencies can also be employed so long as the desired barrier potential is achieved. Although in this embodiment two DC and RF voltage sources are depicted, the functionality for the application of DC and/or RF voltages to various components of the mass spectrometer can be incorporated in a single voltage source, or more than two voltage sources can be employed.

The potential barrier generated via the application of a voltage to the barrier electrode IQ3 can be configured to trap the precursor ions (or at least most of those ions) behind the barrier electrode. In other words, the collisional cooling of the precursor ions can reduce the ions' kinetic energy such that they will not be able to overcome the potential barrier generated via the application of DC and/or RF voltages to the barrier electrode IQ3 and hence accumulate in a region behind that electrode.

It should be understood that although the accumulation of the precursor ions behind the barrier electrode IQ3 is herein described in some cases as trapping those ions, in embodiments disclosed herein, the potential barrier generated by the barrier electrode is not changed so as to release ions from the collision cell. Rather, as discussed in more detail below, as the photo fragmentation of the trapped ions continues and as new ions arrive to be trapped by the potential barrier, the space charge in the region in which the ions are trapped continues to grow until the repulsion generated by the space charge imparts sufficient kinetic energy to the fragment ions, and in some cases the precursor ions as well, so that they can overcome the potential barrier to exit the collision cell.

With continued reference to FIG. 1, the mass spectrometer 100 further includes a source of ultraviolet (UV) radiation 206 that is radiatively coupled to the collision cell Q2, via UV transparent windows 210a and 210b, to irradiate the ions trapped behind the exit electrode IQ3. The UV transparent window 210a is coupled to a wall of an evacuated chamber 211 in which the collision cell Q2 is positioned and the UV transparent window 210b is provided in a portion of an outer wall of the collision cell Q2.

The wavelength of the UV radiation is selected so as to be absorbed by at least one chromophore present in the molecular structure of the trapped ions so as to cause photo fragmentation of at least a portion thereof within a region in proximity of the exit electrode in which the ions are trapped. By way of example, and without limitation, the wavelength of the UV radiation can be, for example, in a range of about 200 nm to about 400 nm, but other wavelengths can also be employed based on the absorption characteristics of an ion of interest.

In this embodiment, one or more optics 208, e.g., a pair of UV lenses, are positioned in the radiation path of the UV radiation generated by the UV radiation source 206 to guide (e.g., focus) the radiation into the region behind the barrier electrode IQ3 in which the precursor ions are accumulated. In embodiments, the angle of the entry of the UV radiation can be selected to optimize the interaction of the UV radiation with the trapped ions. By way of example, the angle of entry of the UV radiation into the collision cell relative to a putative vector that is normal to the barrier electrode can be in a range of about 0 degrees to about 0.5 degrees, such as 0.3 degrees.

In embodiments, a variety of commercially available UV radiation sources can be employed. Some examples of such UV radiation sources include, without limitation, the 355 nm Spectra Physics Explorer One 10 kHz repetition rate laser and the 266 nm TEEM Photonics 20 kHz repetition rate SNU-20F-100 laser.

As the ions undergo photofragmentation to generate a plurality of fragment ions (herein also referred to as product ions) and as new ions arrive to be trapped by the potential barrier, the space charge in the region in which the ions are trapped continue to increase until the repulsive forces between the ions is sufficiently strong such that the product ions (and in some cases, some precursor ions) acquire enough kinetic energy to overcome the potential barrier generated by the barrier electrode IQ3 for exiting the collision cell via an orifice IQ3a provided in the electrode IQ3.

The product ions generated by the photofragmentation of the precursor ions in the collision cell Q2 are received by a downstream quadrupole mass analyzer Q3 via the ion lens IQ3 and a stubby lens ST3, which help focus the product ions into the quadrupole mass analyzer Q3. Although in this embodiment the downstream mass analyzer is a quadrupole mass analyzer, in other embodiments it can be another type of mass analyzer, e.g., a time-of-flight (ToF) mass analyzer or an ion trap.

In this embodiment, the quadrupole mass analyzer Q3 includes four rods that are arranged relative to one another in a quadrupole configuration and to which RF and/or DC voltages can be applied in a manner known in the art to provide mass analysis of the product ions. The ions passing through the mass analyzer Q3 are received and detected, after passage through ion lenses 119, by a downstream detector 118, which generates ion detection signals in response to the incident ions.

An analysis module 124 (herein also referred to as an analyzer) in communication with the detector 118 receives the ion detection signals and processes the ion detection signals to generate a mass spectrum of the product ions, thereby allowing monitoring MRM transitions by fixing Q1 on a precursor m/z of interest, fragmenting the precursor ions (or at least a portion thereof) in the collision cell Q2, and fixing Q3 on a product ions of interest.

Since photofragmentation of an ion will occur only if the ion would absorb the UV energy to which that ion is exposed, in embodiments the UV photofragmentation can provide a highly selective fragmentation of the ions and significantly reduce chemical noise contribution that could occur with less selective fragmentation approaches, such as collision induced dissociation (CID).

In particular, in this embodiment, a controller 1000 is operably coupled to the UV laser 206 to control the emission of radiation generated by the UV laser. By way of example, in some embodiments, the controller can be programmed to activate and deactivate the UV radiation source 206, e.g., according to a predefined temporal schedule.

Although in this embodiment the potential barrier for inhibiting the passage of the ions is provided at the outlet of the collision cell, in other embodiments an electrode to which a DC and/or an RF voltage can be applied for generating a potential barrier can be coupled to the collision cell at other locations.

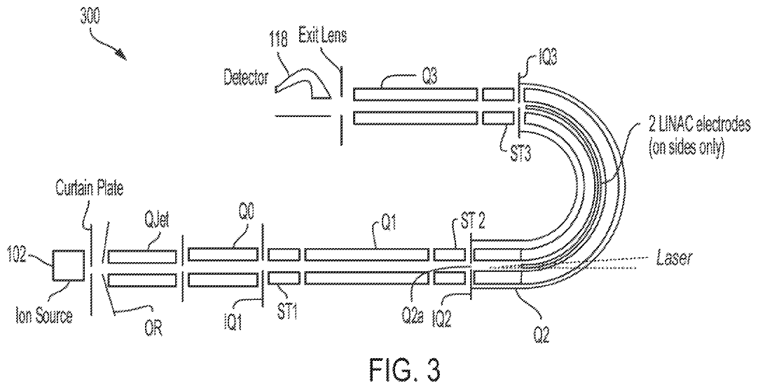

By way of example, FIG. 3 schematically depicts an embodiment of a mass spectrometer 300 according to the present teachings, which is similar to the mass spectrometer 100 described above (for ease of description, various elements (such as the voltage sources) are not shown in FIG. 3) except that the mass spectrometer 300 is configured to create a potential barrier in a region in vicinity of its inlet Q2a. More specifically, in this embodiment the DC voltage applied to the linac electrodes 115a/115b is configured so as to trap the ions entering the collision cell in a region between the entrance ion lens IQ2 and the proximal ends of the linac electrodes.

The distance between the proximal end of the linac electrodes and the inlet of the collision cell is selected so as to allow the ions entering the collision cell to undergo sufficient collisional cooling such that they can be trapped in the region between the entrance and the proximal ends of the linac electrodes.

Similar to the mass spectrometer 100, the UV radiation source 206 (not shown in this figure) is radiatively coupled to the collision cell Q2 so as to cause photofragmentation of the precursor ions (or at least a portion thereof) that are trapped via the potential barrier generated by the linac electrodes. In particular, similar to the previous embodiment, a pair of radiation transmission windows similar to those utilized in the previous embodiment can allow the introduction of the UV radiation generated by the UV radiation source into the region in which the ions are accumulated such that the absorption of the UV radiation by the trapped ions (or at least a portion thereof) will cause their photofragmentation.

Similar to the previous embodiment, one or more optics (not shown in this figure), such as one or more UV lenses, can guide and focus the UV radiation into the region in which the ions are trapped (i.e., accumulated). As discussed above, the absorption of the UV radiation by at least a portion of the trapped ions can cause photofragmentation thereof to generate a plurality of product ions. As discussed above, as the photofragmentation of the precursor ions continues and new precursor ions arrive at the potential barrier, the space charge in the proximity of the potential barrier increases until the kinetic energy imparted to the product ions (and in some cases, some of the precursor ions, as well) is sufficient to allow the product ions (and in some cases, some of the precursor ions) to overcome the potential barrier (a DC potential barrier in this embodiment) and propagate to the outlet of the collision cell through which they can exit the collision cell.

Again, similar to the previous embodiment, the product ions exiting the collision cell are received by a mass analyzer (which is a quadrupole mass analyzer Q3 in this embodiment), which allows acquiring a mass spectrum of the product ions in a manner discussed above.

In the above embodiments, the precursor ions (or most of the precursor ions) received by the collision cell Q2 do not undergo collisional fragmentation and are accumulated in a region in proximity of a potential barrier created in the collision cell to undergo photofragmentation via absorption of the UV radiation.

In other embodiments, the energy of the precursor ions and the pressure of the gas contained in the collision cell can be selected such that the precursor ions received by the collision cell (or at least a portion thereof) will undergo CID to generate a first set of fragment ions. In such embodiments, the potential barrier created in the collision cell can be configured to provide trapping of such fragment ions (or at least a portion thereof) in a region in proximity of the potential barrier.

These CID-generated fragment ions (herein also referred to as the first set of fragment ions) can then be exposed to UV radiation generated by a UV radiation source to undergo photofragmentation so as to generate another set of fragment ions (herein referred to as the “product ions”). These product ions (or at least a portion thereof) can overcome the potential barrier once the space charge in proximity of the potential barrier reaches a threshold at which the kinetic energy of at least some of the ions is greater than the potential barrier.

The motion of the ions overcoming the potential barrier along the collision cell is facilitated via an axial electric field that is generated by the linac electrodes in a manner discussed above. In some embodiments the final product ions do not undergo any further collisional fragmentation as they travel along the collision cell to reach its outlet. In other embodiments, at least a portion of the final product ions can undergo collisional fragmentation as they travel through the collision cell to arrive at its outlet.

Similar to the previous embodiments, the ions exiting the collision cell are received by a quadrupole mass analyzer Q3, which can be scanned to allow passage of ions with different m/z ratios therethrough for detection via the downstream detector 118. The ion detection signals generated by the downstream detector are then analyzed by the analysis module (not shown), similar to the analysis module 124 discussed above, to generate a mass spectrum of the detected ions.

In some embodiments, two or more UV radiation sources emitting radiation at the same or different wavelengths can be utilized, together with two potential barriers generated in the collision cell, to provide two or more photofragmentation regions in one of which (e.g., the one closest to the inlet of the collision cell) a set of precursor ions are initially photofragmented into a plurality of fragment ions (herein also referred to as the first set of fragment ions) and those fragment ions undergo additional fragmentation in one or more subsequent photofragmentation regions to generate a second set of fragment ions.

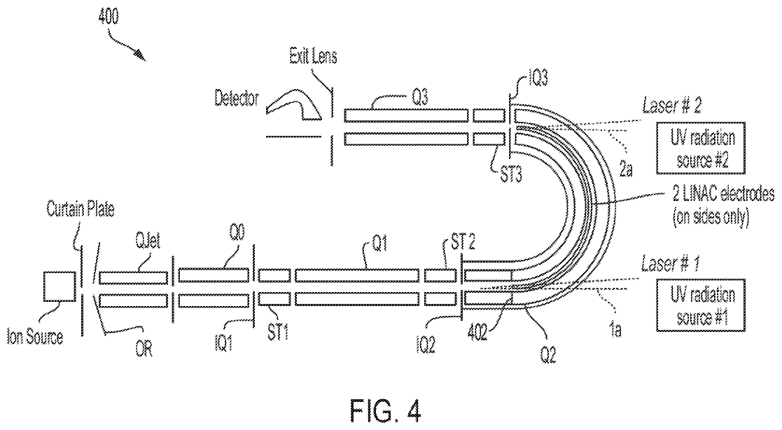

By way of example, FIG. 4 schematically depicts a mass spectrometer 400 according to such an embodiment, which is similar to the above mass spectrometers 100 and 300 in all respects except that in this embodiment two barrier electrodes 402 and IQ3 are coupled to a collision cell 406 with the barrier electrode 402 positioned in proximity of the inlet 406a of the collision cell and the barrier electrode IQ3 positioned at the outlet of the collision cell.

Similar to the previous embodiments, the DC voltage source and the RF voltage source (not shown in this figure) can apply the requisite DC and/or RF voltages to the barrier electrodes 402 and IQ3 to generate potential barriers for inhibiting the passage of ions arriving at the barrier electrodes, thereby causing those ions to accumulate in regions in proximity of those electrodes.

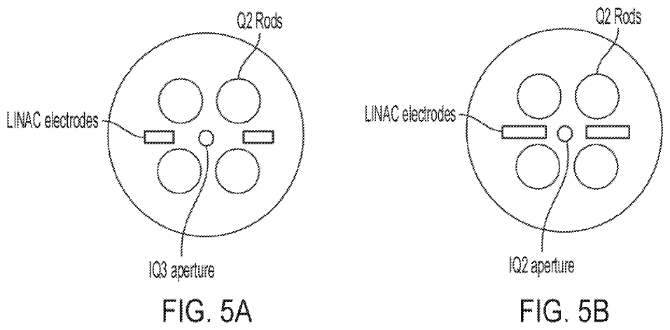

Further, similar to the other embodiments, a pair of linac electrodes is incorporated in the collision cell to facilitate the transit of ions along the collision cell. By way of further illustration, FIGS. 5A and 5B schematically depict, respectively, the cross sections of the collision cell incorporated in the mass spectrometer of FIG. 4, where FIG. 5A presents a view from the outlet end of the collision cell and FIG. 5B presents a view from the inlet end of the collision cell, further illustrating the positions of the linac electrodes relative to the quadrupole rods.

More specifically, a controller (such as the controllers discussed above) can cause the DC and/or RF voltage sources to apply DC and/or an RF voltages to the barrier electrodes 402/IQ3 suitable for trapping ions in proximity of the barrier electrode 402 and IQ3.

In this embodiment, the mass spectrometer 400 further includes two UV radiation sources, namely, UV radiation source #1 and UV radiation source #2 that operate under the control of a controller to generate UV radiation for causing photofragmentation of ions trapped by the barrier electrodes 402 and IQ3.

In this embodiment, the UV radiation source 1 generates a UV radiation beam 1a that is guided via one or more optics, such as those discussed above, and a UV-transparent window (not shown in this figure) that is provided in at least a portion the collision cell wall to irradiate at least a portion of the precursor ions trapped by the barrier electrode 402 in a region in proximity thereof. The wavelength of the UV radiation generated by the UV radiation source 402 is selected such that the UV radiation is absorbed by least a portion of the irradiated precursor ions and cause their photofragmentation.

Similar to the previous embodiment, the UV radiation generated by the UV radiation source is directed into the collision cell to interact with the ions trapped by each of the potential barriers generated by the barrier electrodes 402/IQ3 at an angle that can maximize the interaction of the UV radiation with those ions. By way of example, such an angle can be, without limitation, in a range of about 0 degrees to about 0.5 degrees, such as 0.3 degrees.

The ion fragments generated via photofragmentation of at least a portion of the precursor ions via the UV radiation generated by the UV source 1 (herein also referred to as the first set of ion fragments) propagate through the curved collision cell. Similar to the previous embodiments, the propagation of these ions is assisted via a pair of linac electrodes disposed in the collision cell, e.g., in a manner discussed above in connection with the previous embodiments.

The first set of ion fragments (or at least a portion thereof) are then trapped via a potential barrier generated by the barrier electrode IQ3 in a region in vicinity of thereof. In this embodiment, the second barrier electrode is in the form of an exit lens that is coupled to the collision cell at the outlet thereof and is configured for application of DC and/or RF voltages thereto to generate a potential barrier for inhibiting the passage of the first set of fragment ions (or at least a portion thereof), thereby causing at least a portion of such fragment ions to accumulate behind the barrier electrode IQ3.

The UV radiation source 2 generates a UV radiation beam 2a, which is directed, via one or more optics (such as one or more lenses) and through a transparent window provided in the wall of the collision cell, into the region of the collision cell in vicinity of the barrier electrode IQ3, where the first set of fragment ions is accumulated to irradiate at least a portion of those fragment ions and cause photofragmentation thereof.

More specifically, the wavelength of the UV radiation generated by the UV radiation source 2 is selected such that the UV radiation will be absorbed by the first set of ion fragments (e.g., via a chromophore of those ion fragments) and cause photofragmentation of at least a portion thereof to generate a second set of ion fragments. In other words, the UV radiation generated by the UV radiation source 2 causes a second photofragmentation of the precursor ions entering the collision cell.

Typically, the wavelengths of the UV radiation generated by the UV radiation sources 1 and 2 are different. For example, the UV radiation generated by the UV radiation source 1 can be selected such that the UV radiation generated by that source is absorbed by one chromophore of the precursor ions and the UV radiation generated by the other UV radiation source (namely, the UV radiation source 2) is absorbed by another chromophore of the precursor ions so as to result in successive photofragmentation of the precursor ions. Some examples of UV laser wavelengths can be 350 nm, 355 nm, 266 nm, and 213 nm.

In some embodiments, the laser radiation can be modulated and the collision cell can be configured such that in certain time intervals, photofragmentation of precursor ions is achieved via photofragmentation and in other time intervals, the laser radiation is off and precursor ions are fragmentated via CID. By way of example, such a dual fragmentation approach can be implemented by periodically switching the laser radiation on and off such that when the laser radiation is on, the ions trapped in proximity of the potential barrier undergo photofragmentation and when the laser is off, the ions undergo CID as they pass through the collision cell. In some embodiments, the collision energy of the ions during the period when the laser radiation is on can be selected to be in a range of about 5 to above 10 eV so as to inhibit collisional fragmentation of the ions prior to their photofragmentation due to exposure to the laser radiation. Such activation/deactivation of the laser radiation can be done across a single LC peak, or across multiple LC peaks.

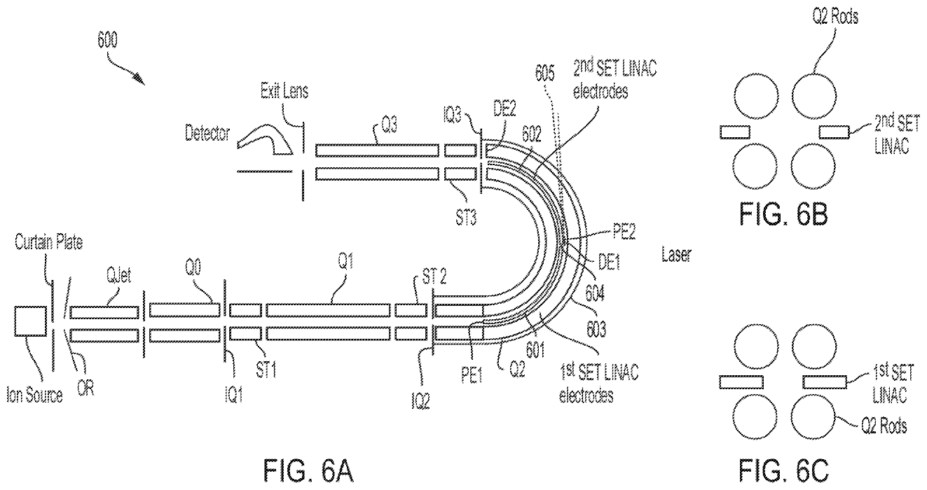

FIGS. 6A, 6B, and 6C schematically depict a mass spectrometer 600 according to another embodiment that is similar to the mass spectrometer 100 discussed above except that the mass spectrometer 600 includes two sets of linac electrodes 601 and 602 that are incorporated in a collision cell 603. The first set of linac electrodes 601 extends from a proximal end (PE1) to a distal end (DE1) and the second set of linac electrodes 602 extends from a proximal end (PE2) to a distal end (DE2), where the distal ends of the first set of linac electrodes and from the proximal ends of the second set of the linac electrodes by a gap region 604 of the collision cell in which ions received by the collision cell via its inlet can be trapped.

More specifically, DC voltages applied, via a DC voltage source (not visible in the FIG. 6A), to the first and the second set of the linac electrodes generates a DC potential difference between the two sets of the linac electrodes to generate a potential barrier that inhibits the passage of ions reaching the gap region 604 into the region of the collision cell in which the second set of linac electrodes is positioned.

A UV radiation source (not show in this figure) generates a UV radiation beam 605 that is directed via one or more optics (not shown in this figure) into the gap region 604 in which a plurality of ions are trapped due to the potential barrier generated via voltages applied to the linac electrodes. By way of example, the introduction of the UV radiation beam into the gap region between the two linac electrodes can cause photofragmentation of at least a portion of the trapped ions to generate a plurality of fragment ions (product ions). Similar to the above embodiments, as the number of the fragment ions increases and as new precursor ions arrive at the potential barrier, the space charge in the vicinity of the potential barrier reaches a level at which the product ions (and in some cases, some of the precursor ions) can overcome the potential barrier and exit the gap region between the distal and proximal ends of the linac electrodes.

With continued reference to FIGS. 6A, 6B, and 6C, in some implementations, the gas pressure within the collision cell and the energy of the ions entering the collision cell are such that at least a portion of the ions entering the collision cell via its inlet undergo collisional fragmentation to generate a first set of fragment ions, which are then trapped in the gap region between the linac electrodes. The first set of fragment ions can undergo photofragmentation via exposure to the UV radiation and its absorption so as to generate a second set of fragment ions, which accumulates within the gap region 604 until the kinetic energy imparted to the product ions (and in some cases, some of the precursor ions) is sufficiently high to allow them to overcome the potential barrier.

In other implementations, the energy of the ions entering the collision cell via its inlet and the gas pressure within the collision cell can be selected such that the ions entering the collision cell will not undergo collisional fragmentation while propagating from the inlet of the collision cell to the gap region within which they will be trapped.

The following examples provide further elucidation of various aspects of the present teachings and are not presented to indicate necessarily optimal ways of practicing the present teachings and/or optimal results that may obtained.

### EXAMPLES

### Example 1

The performance of a prototype mass spectrometer based on the design shown in FIG. 1 has been characterized using testosterone as an analyte. Typical analysis of testosterone (or synthetic steroids) within a blood sample involves the use of a blood sample collection tube, such as the one marketed by Becton, Dickinson and Company (BD) under a trade name Vacutainer®. There are different types of Vacutainer products depending on their intended use. For example, for serum separating applications, a Vacutainer with a gold-colored cap is typically used, which includes a gel-like agent that promotes clotting and separation of blood cells from serum. The promotion of clotting facilitates centrifugal extraction of the clear serum for analysis. Also, for plasma applications, a Vacutainer with a green-colored cap is typically used, which includes an anticoagulant agent such as heparin. The prevention of clotting facilitates the analysis of blood plasma.

However, as will be discussed in more detail below, the clot activator or anticoagulant chemically interferes with the testosterone analysis, and conventional CID methods are susceptible to such chemical interference. On the other hand, in embodiments, using the UVPD concept, the chemical interference can be minimized, and preferably eliminated, and a significantly lower detection limit with higher confidence may be achieved.

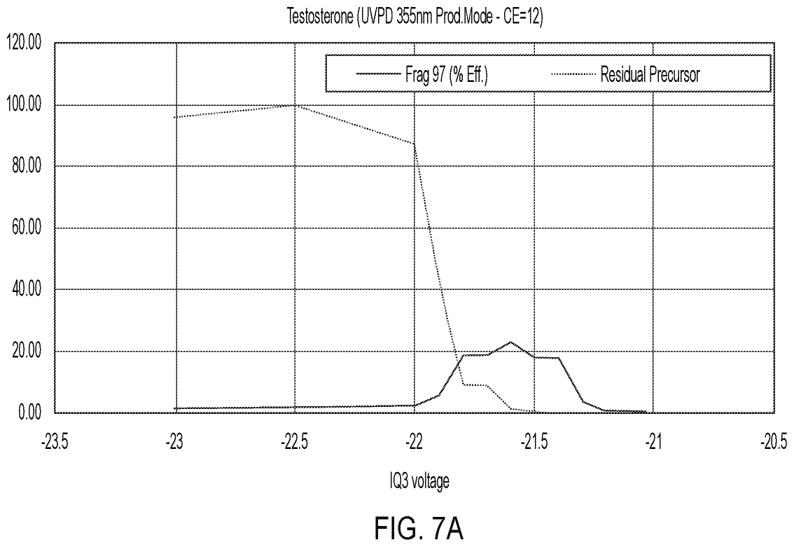

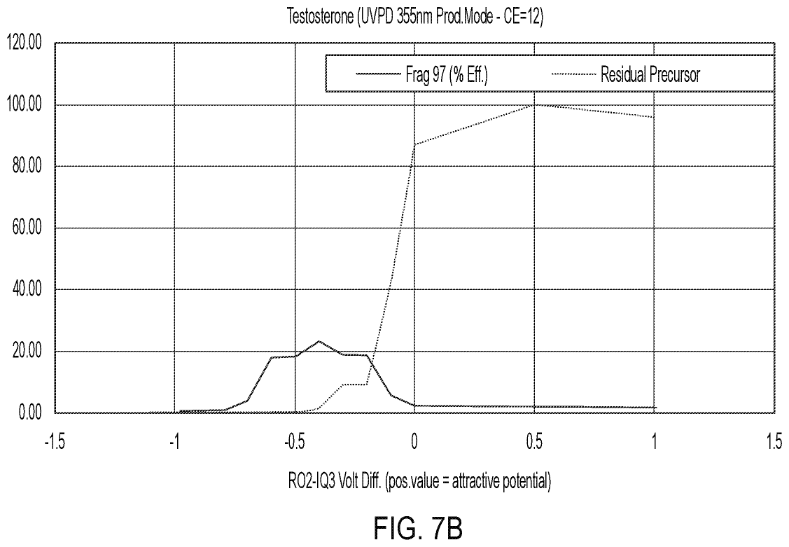

In order to optimize a DC voltage applied to the IQ3 electrode for UVPD-MRM mode, the testosterone level was measured as a function of the IQ3 voltage, and the results are depicted in FIGS. 7A and 7B. It should be noted that similar results can be obtained with other compounds as well. FIG. 7A shows the mass signal intensity associated with a precursor ion m/z 289 and a fragment of the precursor ion at m/z 97 as a function a negative DC voltage and FIG. 7B shows the mass signal intensity associated with the same precursor ion at m/z of 289 as a function of the voltage differential between RO2 (rod offset voltage 2) and IQ3. That is, the barrier is created by the voltage differential applied across the IQ3 and RO2.

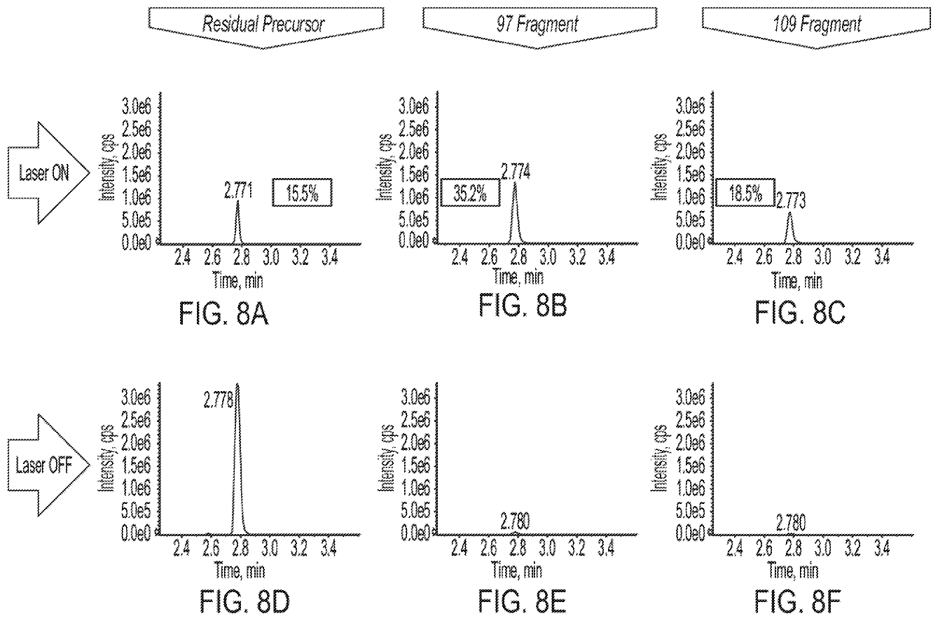

FIGS. 8A, 8B, and 8C present normalized mass signals corresponding to a precursor testosterone ion as well as fragment ions at m/z ratios of 97 and 109 with the UV laser on to cause photofragmentation of the precursor ions. FIGS. 8D, 8E, and 8F present normalized mass signals corresponding to the same precursor and fragment ions with the UV laser off. The data presented in FIGS. 8A-8F show that UV radiation can be used for photofragmentation of precursor ions that were trapped in a region in proximity of the IQ3 electrode.

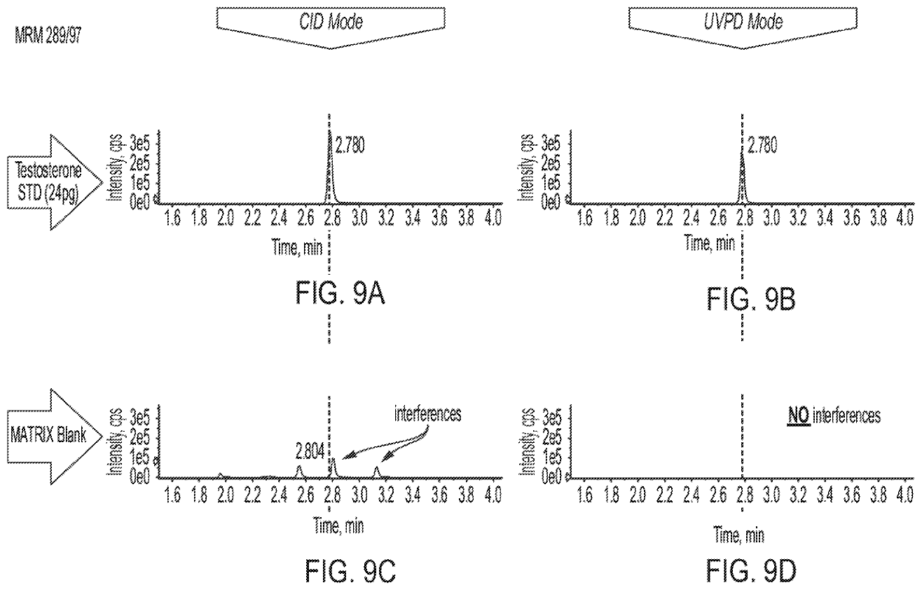

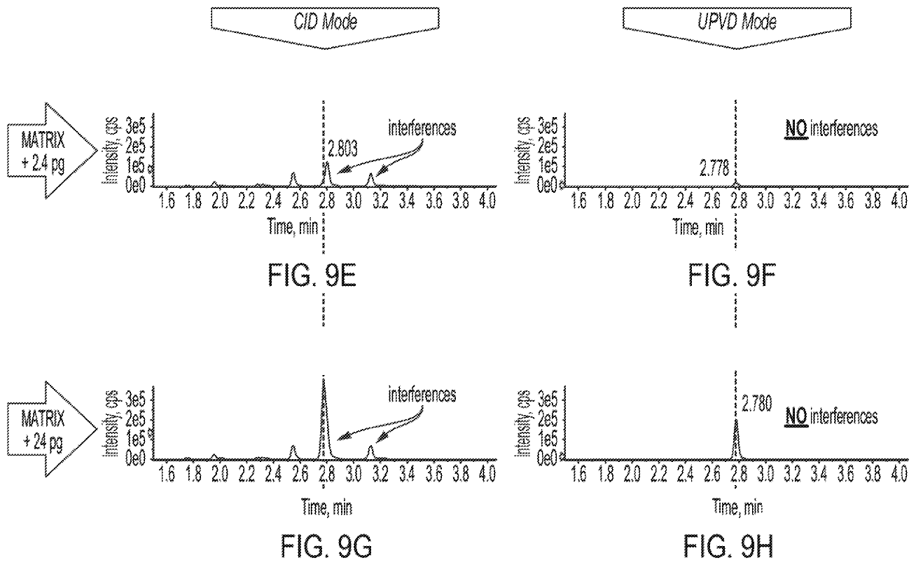

FIGS. 9A-9H show the impact of a clot activator gel matrix on testosterone mass signals using CID and UVPD fragmentation modes. More specifically, FIGS. 9A and 9B show the MRM 298/97 mass signal for a sample of 24 μg of pure testosterone standard using CID and UVPD fragmentation modes, respectively. The data shows that for the pure testosterone standard sample, both the CID and the UVPD modes are both capable of providing fragmentation of the precursor ions at an m/z of 280 to generate fragment ions at an m/z of 97 with a fragmentation efficiency that allows for clear detection of the MRM 289/97 mass signal.

Referring now to FIG. 9C, the mass spectrum of a gel matrix alone shows several mass peaks around MRM 289/97 mass signal, which overlap with the testosterone peak and might interfere with the testosterone measurement. In contrast, the mass spectrum of the gel matrix alone using UVPD mode, presented in FIG. 9D, shows no mass peaks around the MRM 289/97 mass transition. Thus, it is expected that the use of CID fragmentation mode for detecting MRM 289/97 mass signal of testosterone in a gel matrix could lead to generation of interfering mass signals, which can lead to difficulty in detecting the mass signal associated with testosterone, especially at low testosterone concentrations.

In fact, the data presented in FIG. 9E shows that it is impractical to detect the testosterone MRM 289/97 mass signal associated with 2.4 pg of testosterone incorporated in a gel matrix. In contrast, the data presented in FIG. 9F shows that the MRM 289/97 mass peak associated with 2.4 pg of testosterone incorporated in a gel matrix is readily detectable when using UVPD ion fragmentation.

As shown in FIGS. 9G and 9H, at a higher concentration of testosterone in the sample, both CID and UVPD fragmentation modes can be used to detect the MRM 289/97 mass signal. However, the use of CID mode leads to generation of interfering mass signals while such interfering mass signals are absent from the mass spectrum obtained using the UVPD fragmentation mode.

In summary, the data presented in FIGS. 9A-9H demonstrate that the UVPD fragmentation mode can provide improved detection limit for testosterone over the CID mode in the presence of the clot activator gel matrix.

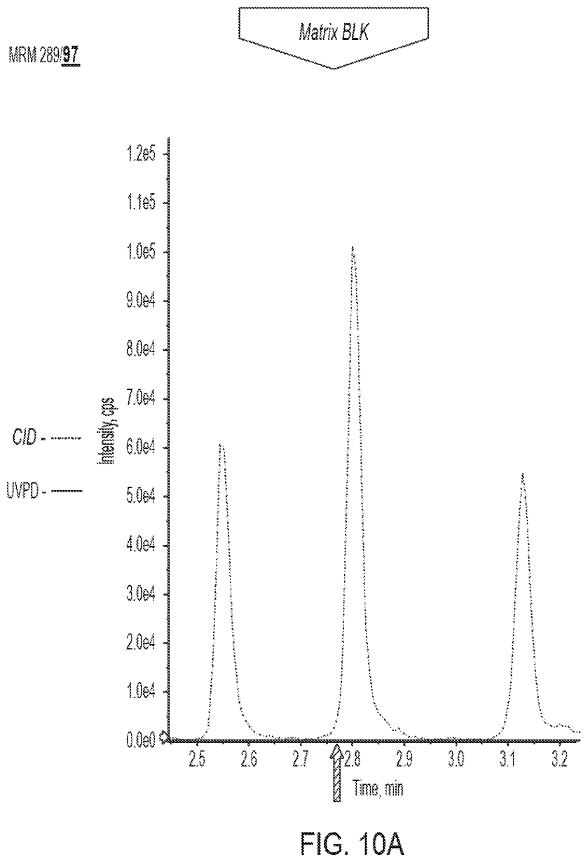

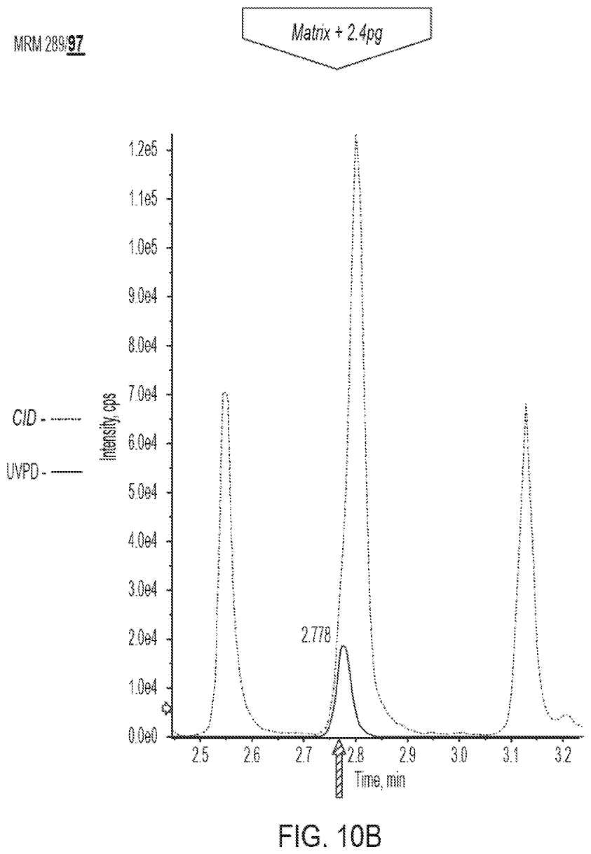

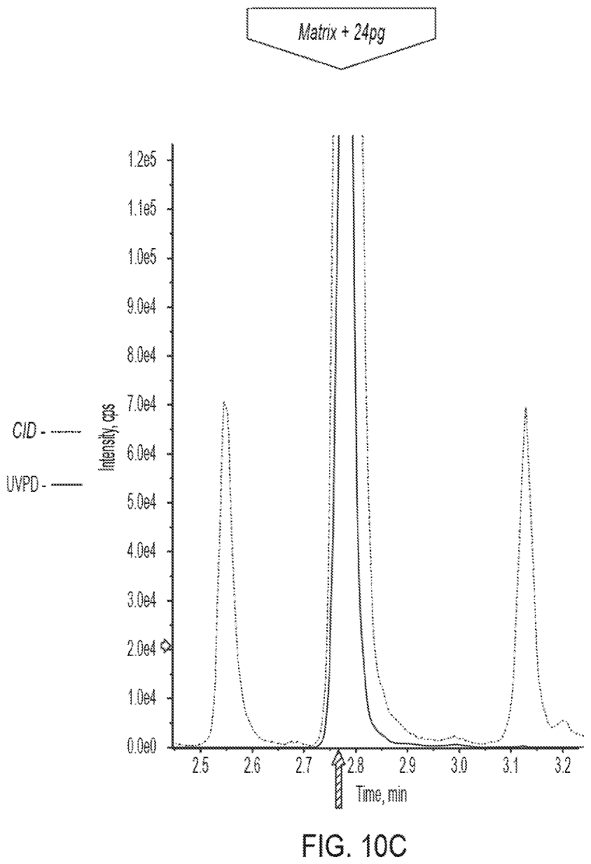

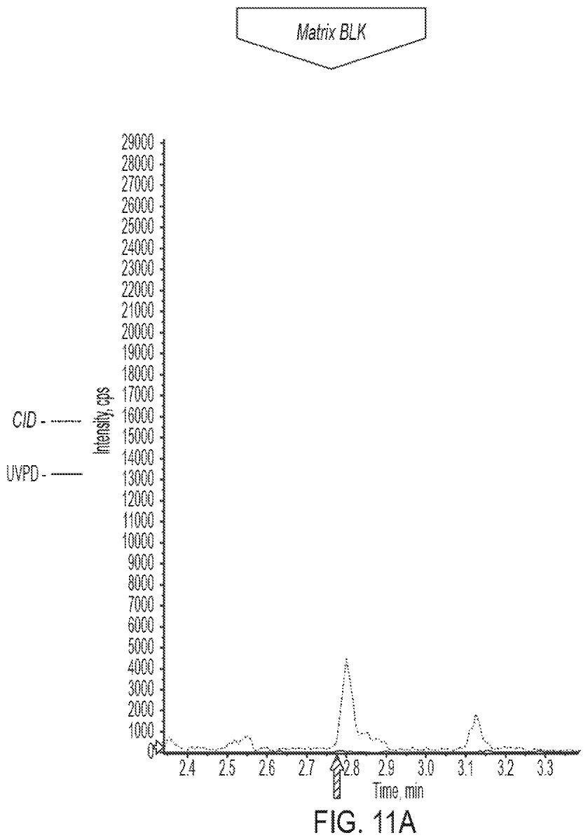

FIGS. 10A, 10B, and 10C show total mass signals as a function of elution time for a blank gel matrix, a sample containing 2.4 pg of testosterone in a gel matrix, and a sample containing 24 μg of testosterone in a gel matrix. Again, the data presented in FIGS. 10A-10C shows that in embodiments, UVPD fragmentation mode eliminates interfering mass peaks, which could otherwise render spectral analysis of testosterone mass peaks difficult.

Whereas the use of the CID mode can result in interference from mass signals due to the gel matrix and those corresponding to an analyte of interest (in this case, testosterone) and has difficulty with detecting testosterone at a level as low as 2.4 pg, in this example, the use of the UVPD fragmentation mode results in acquiring mass signals of ion fragments associated with testosterone without interference from mass signals associated with the background matrix.

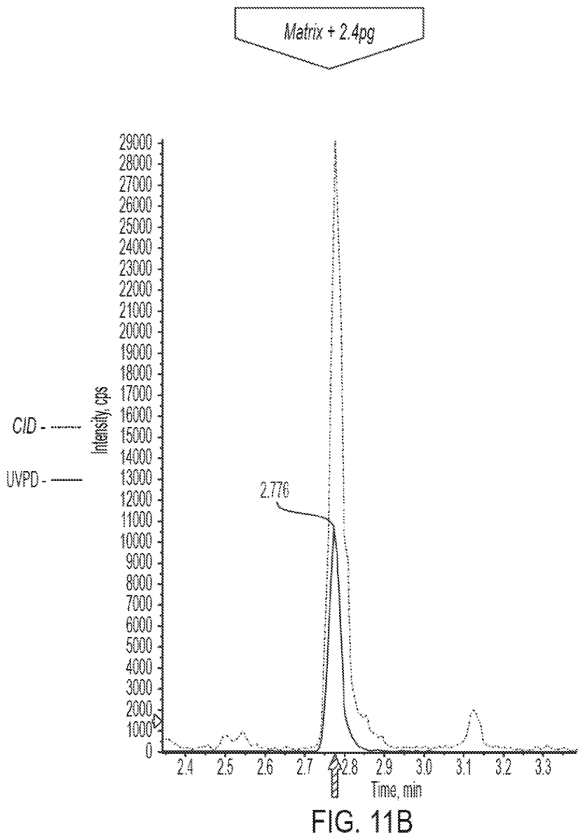

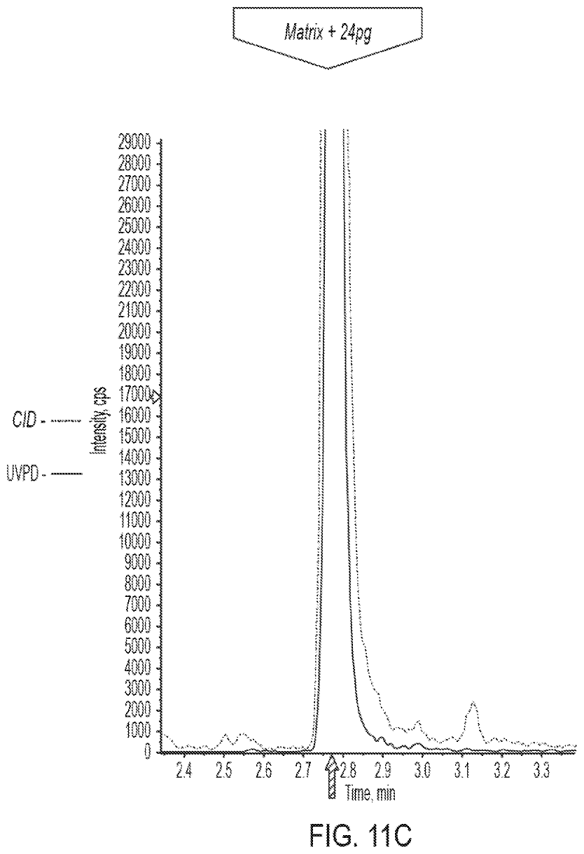

FIGS. 11A, 11B, and 11C provide mass signal data corresponding to a blank gel matrix as well as for the MRM 289/109 transition of two testosterone samples, one of which includes a 2.4 pg of testosterone in a gel matrix and the other includes 24 μg of testosterone in the gel matrix using both CID and UVPD fragmentation modes. Compared to the above MRM 289/97 mass data, the CID mode exhibits slightly less interference, but there are still interfering mass signals in the CID mode. On the other hand, the UVPD mode shows little sign of interference and can detect the MRM 289/109 fragmentation of testosterone at a level as low as 2.4 pg.

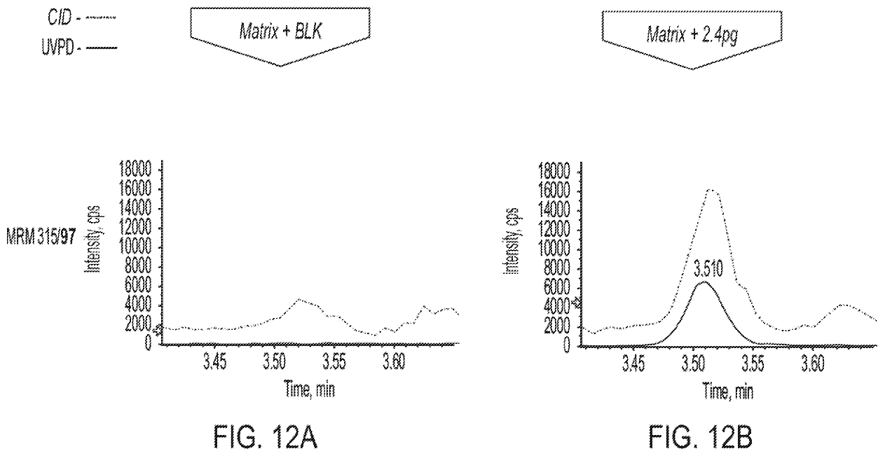

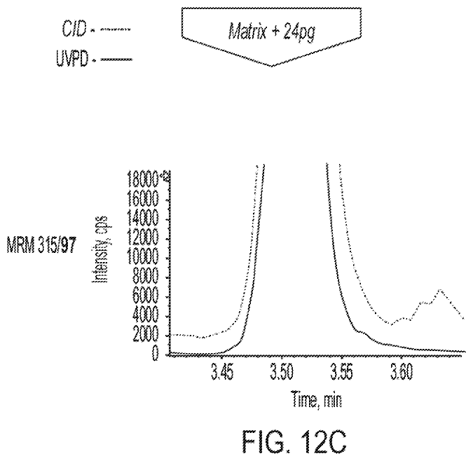

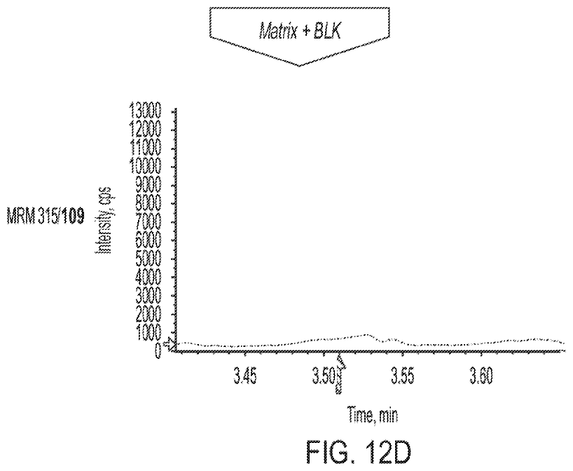

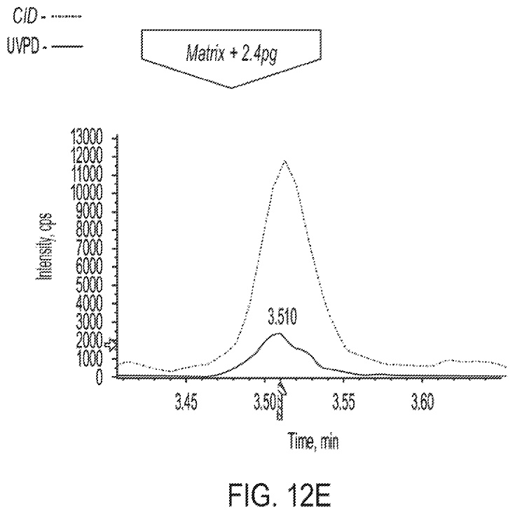

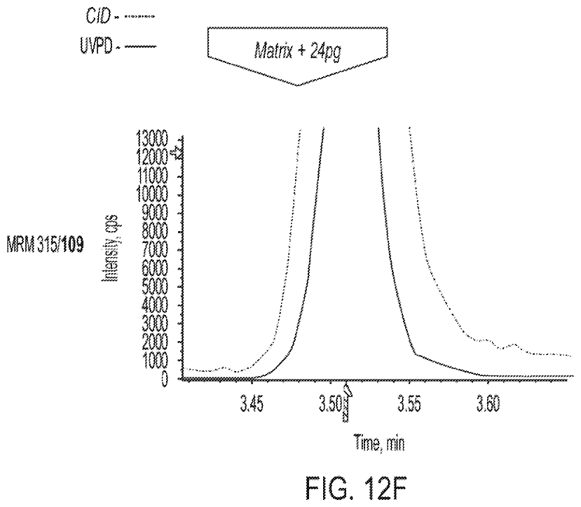

FIGS. 12A-12F show the CID fragmentation mode and the UVPD fragmentation mode measurements for progesterone. The overall results are similar to those discussed above for testosterone measurements. Similar to testosterone, the CID mode suffers interference from the gel matrix at low (2.4 pg) level of progesterone, whereas the UVPD mode suffers no interference.

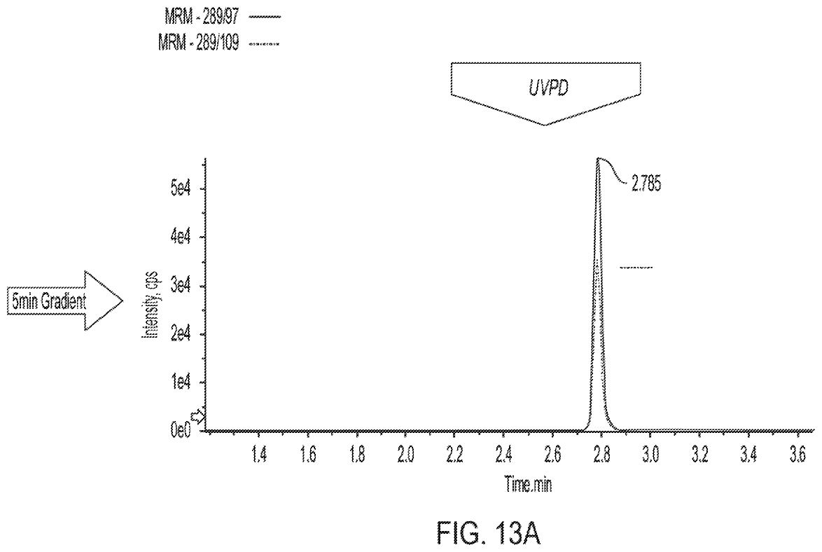

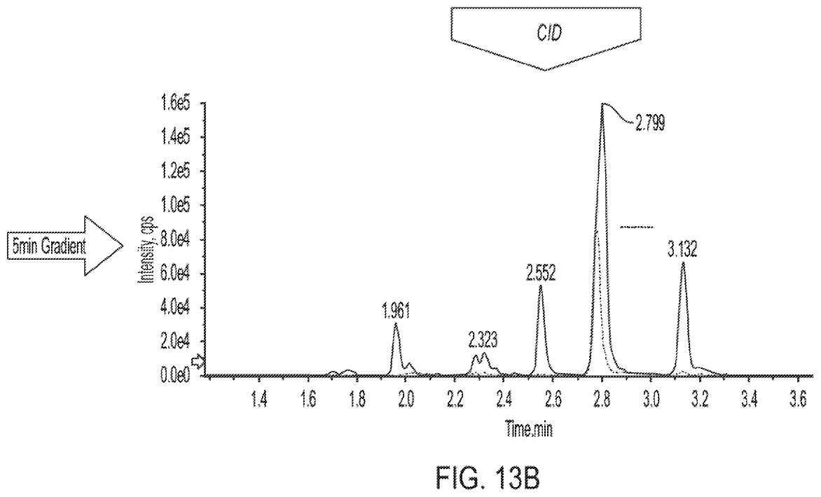

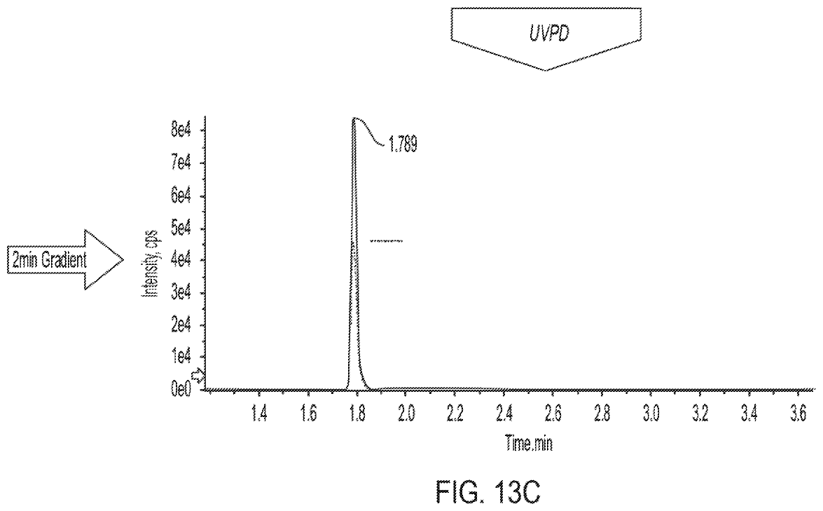

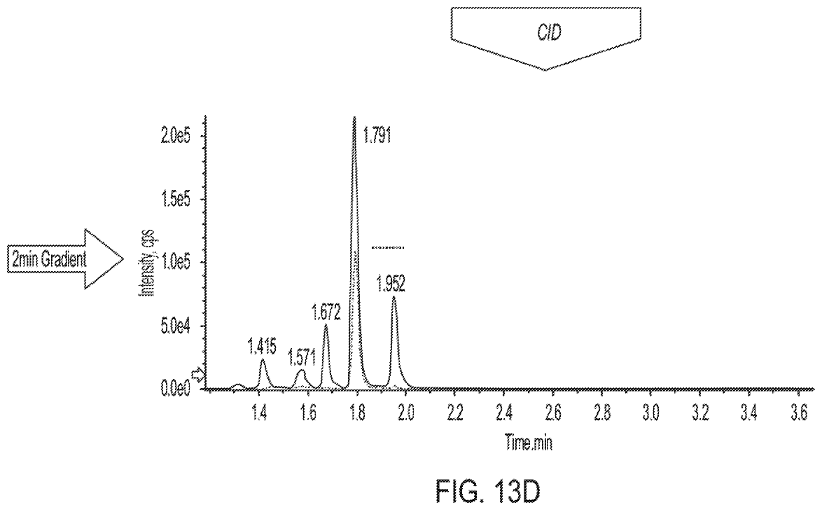

FIGS. 13A and 13B show, respectively, the 289/97 and 289/109 MRM transitions of testosterone acquired using UVPD and CID fragmentation modalities using a 5-minute LC elution gradient. And FIGS. 13C and 13D show the same MRM transitions of testosterone acquired using UVPD and CID fragmentation modalities, respectively, but with a 2-minute LC elution gradient. This data again shows that the use of UVPD fragmentation modality can reduce, and even eliminate, the interference and background noise in the mass spectrum of interest.

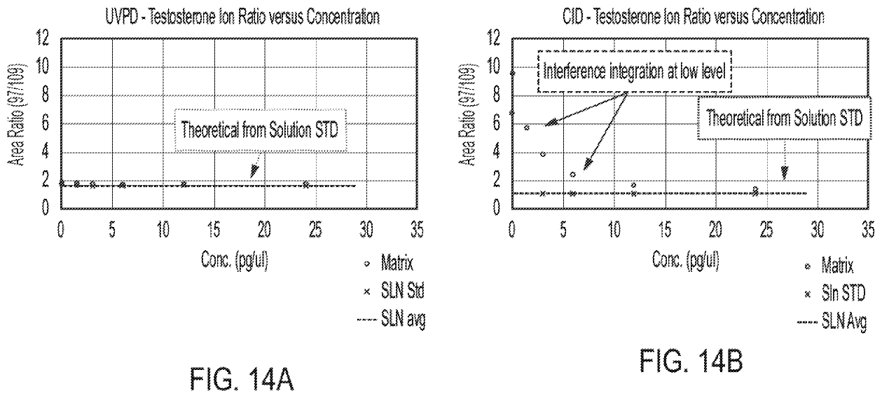

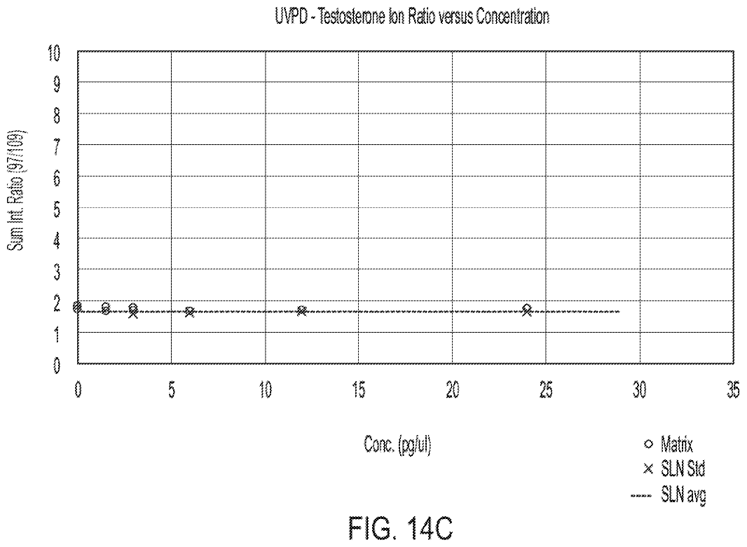

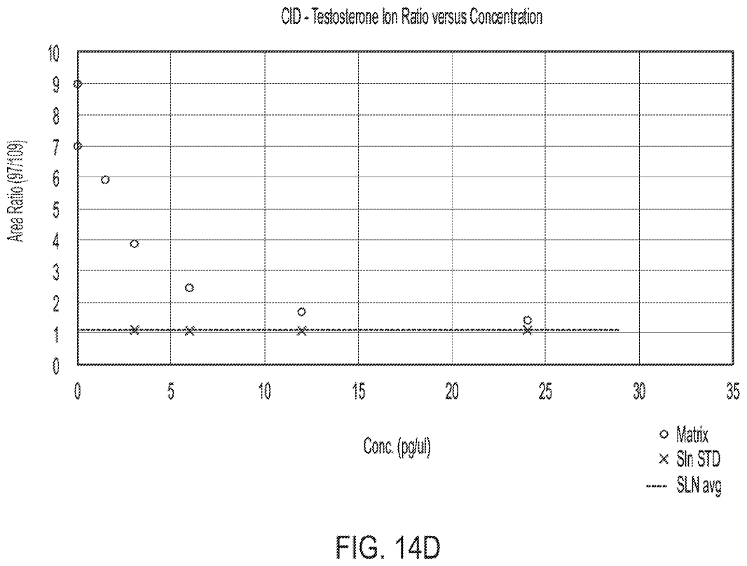

FIGS. 14A and 14B show theoretically-calculated ion ratios versus concentration for a standard testosterone solution for UVPD and CID fragmentation modalities, respectively. And FIGS. 14C and 14D show measured ion ratios versus concentration for a standard testosterone solution for UVPD and CID fragmentation modalities, respectively. This data indicates that at low testosterone concentrations, interference from mass peaks corresponding to the matrix can be observed.

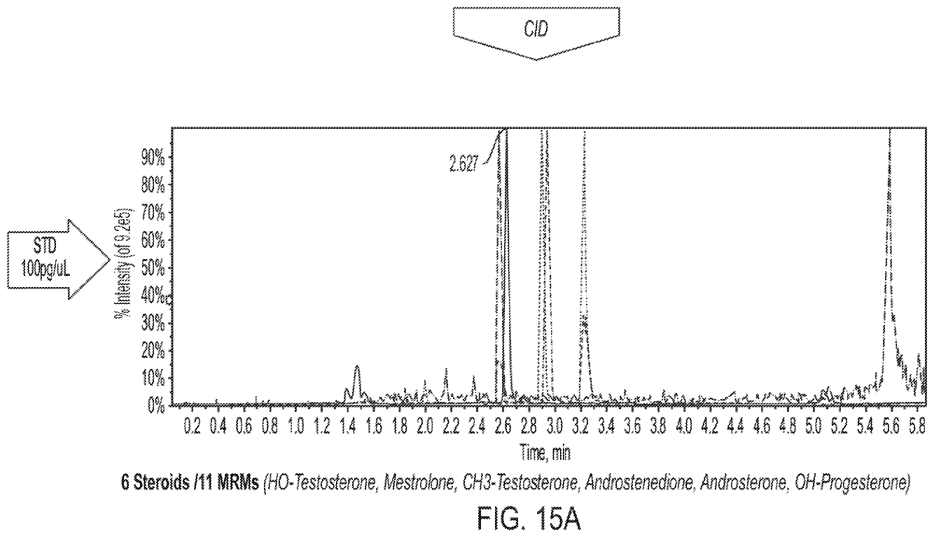

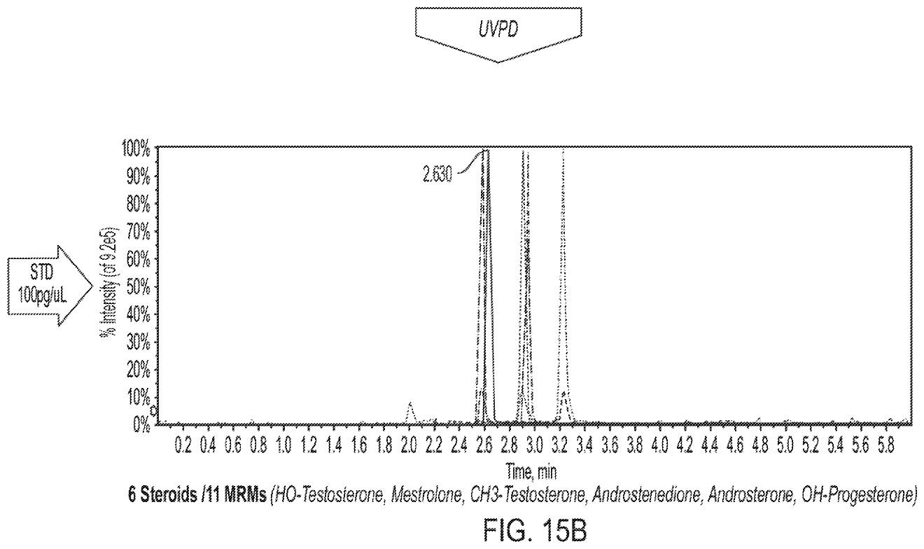

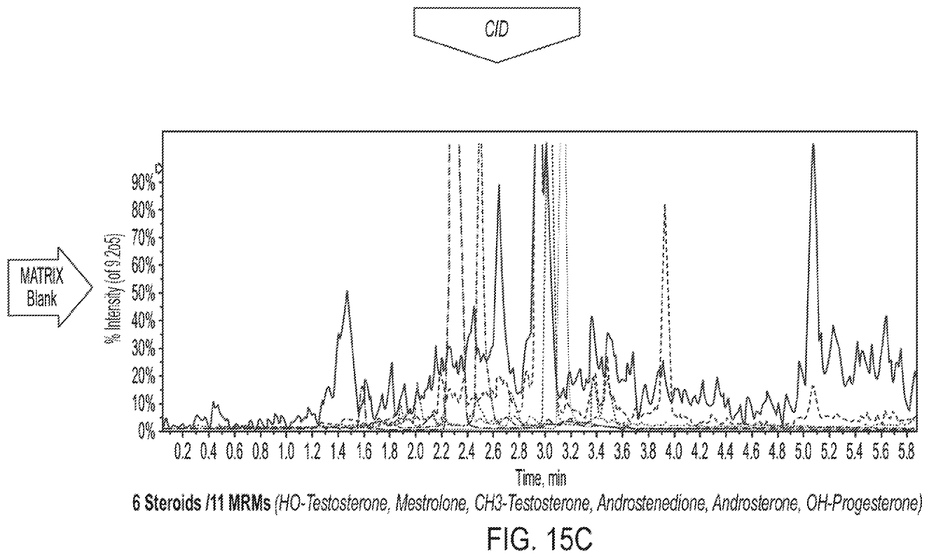

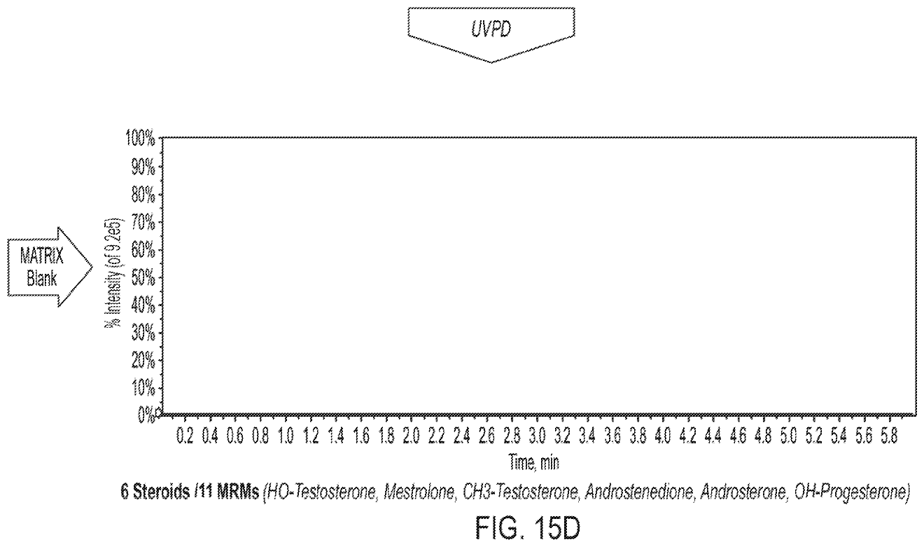

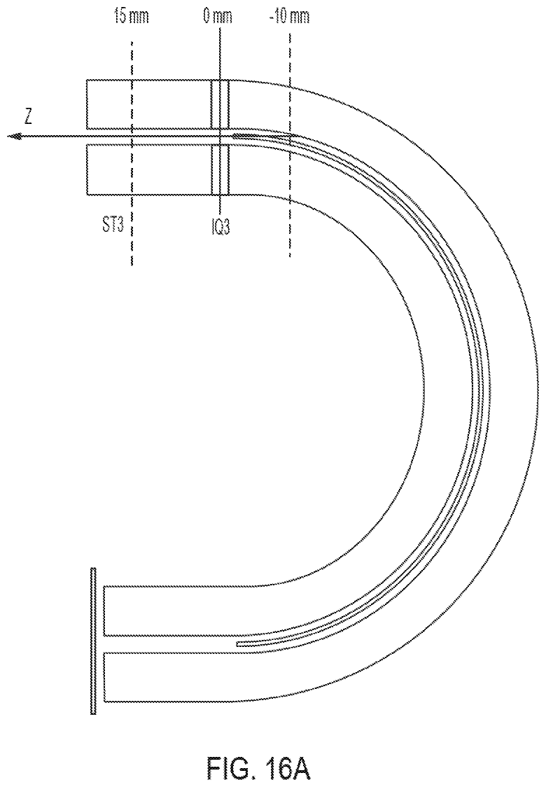

FIGS. 15A-15D show plots of the fragmentation results for 100 pg/μL of a mixture of 6 steroids, namely, HO-Testosterone, Mestrolone, CH3-Testosterone, Androstenedione, Androsterone, OH-Progesterone. Similar to the previously-described experimental results, the UVPD mode shows no interference from the gel matrix, and accordingly, can detect all 6 steroids, whereas the interference by the gel matrix bears significant impact on the CID mode.

### Example 2

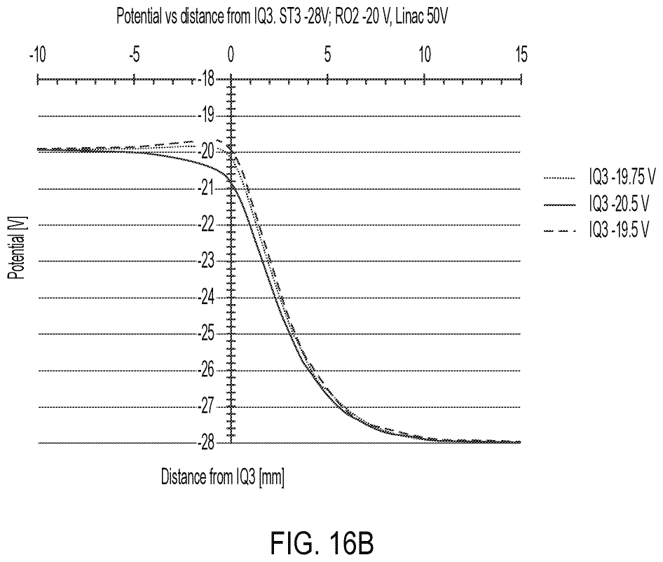

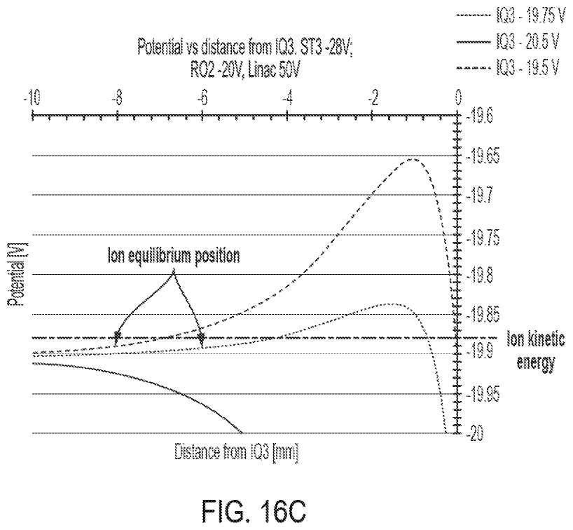

FIG. 16A shows simulated trajectories of a plurality of ions travelling through a collision cell according to an embodiment that includes linac electrodes and in which a DC potential applied to the lens IQ3 positioned in proximity of the collision cell's outlet is employed to generate a potential barrier for inhibiting the ions from exiting the collision cell via an opening provided in the IQ3 lens. The potential barrier results in the accumulation of ions in the vicinity of the outlet of the collision cell. FIG. 16B shows the DC potential as a function of distance from the IQ3 lens for several DC voltages applied to the IQ3 lens.

In general, the equilibrium position of the ions can depend on the potential applied to the linac electrodes, the IQ3 and RO2, the mechanical tolerance in the relative position of IQ3 versus Q2 rod electrodes and ST3 electrodes, the total number of ions as well as on the m/z ratio of the ions.

By way of illustration, FIG. 16C shows theoretical calculations of the equilibrium position of the ions in the collision cell as a function of three DC voltages applied to the IQ3 lens while maintaining the voltages applied to the ST3 electrodes, RO2 and linac electrodes, respectively, at −28 volts, −20 volts, and 50 volts.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill in the art will appreciate that various changes can be made to the above embodiments without departing from the scope of the present teachings.

What is claimed is:

1. A method for fragmenting ions in a mass spectrometer, comprising:
introducing a plurality of precursor ions into a collision cell of a mass spectrometer,
generating a potential barrier in the collision cell to cause at least a portion of ions in the collision cell to be trapped within a region in proximity of said potential barrier, and
applying ultraviolet (UV) radiation to said trapped ions so as to cause fragmentation of at least a portion of any of said precursor ions and fragment ions thereof to generate a plurality of product ions such that a space charge generated in said region in proximity of said potential barrier due to accumulation of ions will impart sufficient kinetic energy to at least a portion of the product ions so as to overcome said potential barrier, thereby exiting said region.

2. The method of claim 1, wherein said potential barrier is created in the collision cell in proximity of an outlet of the collision cell.

3. The method of claim 1, wherein said potential barrier is coupled to the collision cell in proximity of an inlet of the collision cell.

4. The method of claim 1, wherein said potential barrier is coupled to the collision cell at a location between an inlet and an outlet of the collision cell.

5. The method of claim 1, further comprising maintaining said collision cell at a pressure suitable for cooling the ions introduced into the collision cell such said potential barrier is capable of trapping at least a portion of the cooled ions.

6. The method of claim 5, wherein said pressure is in a range of about 1 torr to about 15 torr.

7. The method of claim 1, wherein said potential barrier is in a range of about 0.1 volts to about 1.5 volts.

8. The method of claim 1, further comprising introducing a plurality of ions into a mass filter positioned upstream of said collision cell so as to select a plurality of precursor ions having m/z ratios within a target range for transmission into said collision cell for causing fragmentation thereof via exposure to the UV radiation.

9. The method of claim 1, further comprising transmitting said product ions into a mass analyzer disposed downstream of said collision cell for generating a mass spectrum thereof.

10. The method of claim 9, wherein said mass analyzer comprises any of a quadrupole mass analyzer and a time-of-flight mass analyzer, and wherein optionally said mass analyzer comprises an ion trap.

11. The method of claim 3, wherein said step of coupling the potential barrier comprises coupling at least one electrically conductive electrode to said collision cell and applying any of a DC and RF voltage to said electrode so as to generate said potential barrier.

12. The method of claim 11, wherein said electrode comprises an ion lens positioned in proximity of any of an inlet and an outlet of said collision cell.

13. The method of claim 1, wherein an energy of the ions introduced into the collision cell is selected such that at least a portion of said ions is fragmented via collisional dissociation to generate a first plurality of product ions, wherein said potential barrier is capable of trapping at least a portion of said plurality of product ions in said region.

14. The method of claim 1, wherein said step of applying the UV radiation comprises exposing at least a portion of said first plurality of product ions trapped in said region to said UV radiation so as to cause fragmentation of at least a portion thereof so as to generate a second plurality of product ions such that said second plurality of the product ions can overcome said potential barrier.

15. A mass spectrometer, comprising:
a collision cell having an inlet for receiving ions and an outlet through which ions can exit the collision cell,
at least one electrode coupled to said collision cell and configured for application of a DC and RF voltage thereto to generate a potential barrier for trapping at least a portion of ions in the collision cell within a region in proximity of said electrode, and
a UV radiation source radiatively coupled to said collision cell to irradiate at least a portion of said trapped ions so as to cause fragmentation of at least a portion thereof, thereby generating a plurality of product ions such that at least a portion of the product ions can overcome the potential barrier to exit said region.

16. The mass spectrometer of claim 15, further comprising a mass analyzer positioned downstream of said collision cell for receiving at least a portion of the product ions and generating a mass spectrum thereof.

17. The mass spectrometer of claim 15, further comprising a mass filter positioned upstream of said collision cell, said mass filter being configured to receive a plurality of ions and allowing passage of a plurality of precursor ions having m/z ratios within a target range to said collision cell.

18. The mass spectrometer of claim 15, wherein said collision cell contains a gas at a pressure suitable for causing collisional cooling of at least a portion of the received ions so as to allow said cooled ions to be trapped via said potential barrier, wherein optionally said pressure is in a range of about 1 torr to about 15 torr.

19. The mass spectrometer of claim 15, wherein said electrode comprises an ion lens positioned in proximity of an outlet of said collision cell.

20. The mass spectrometer of claim 15, wherein said collision cell has a curved profile extending from said inlet to said outlet, and wherein optionally said curved profile is a semi-circular profile.
